(19) United States
(12) Patent Application Publication
(10) Pub. No.: US 2013/0303677 A1
(43) Pub. Date: Nov. 14, 2013

(54) COMPOSITION FOR POLARIZING FILM, POLARIZING FILM, AND DISPLAY DEVICE INCLUDING THE POLARIZING FILM

(71) Applicant: SAMSUNG ELECTRONICS CO., LTD., Suwon-si (KR)

(72) Inventors: Myung-Man KIM, Suwon-si (KR); Jong-Hoon WON, Yongin-si (KR); Yong Joo LEE, Suwon-si (KR); Deuk Kyu MOON, Seoul (KR); Myung-Sup JUNG, Seongnam-si (KR)

(73) Assignee: SAMSUNG ELECTRONICS CO., LTD., Suwon-si (KR)

(21) Appl. No.: 13/889,653

(22) Filed: May 8, 2013

(30) Foreign Application Priority Data
May 8, 2012 (KR) 10-2012-0048618
May 7, 2013 (KR) 10-2013-0051318

(51) Int. Cl. G02B 1/08

(52) U.S. Cl. CPC G02B 1/08
USPC 524/508

(57) ABSTRACT

A composition for a polarizing film including a polymer, a dichroic dye, and a liquid crystal oligomer, wherein the liquid crystal oligomer includes a mesogen unit and a kink-forming arylene unit, a polarizing film including the composition, and a display device including the polarizing film.

### CROSS-REFERENCE TO RELATED APPLICATION

This application claims priority to and the benefit of Korean Patent Application Nos. 10-2012-0048618 and 10-2013-0051318, and all the benefits accruing therefrom under 35 U.S.C. §119, the content of which is incorporated herein in its entirety by reference.

### BACKGROUND

1. Field

A composition for a polarizing film, a polarizing film, and a display device including the polarizing film are disclosed.

2. Description of the Related Art

A display device such as a liquid crystal display (“LCD”) and an organic light emitting diode (“OLED”) include a polarizing plate attached to the outside of the display panel. The polarizing plate only transmits light of a specific wavelength and absorbs or reflects other light, so it may control the direction of incident light on the display panel or light emitted from the display panel.

The polarizing plate generally includes a polarizer and a protective layer for the polarizer. The polarizer may be formed, for example, from polyvinyl alcohol (“PVA”), and the protective layer may be formed, for example, from triacetyl cellulose (“TAC”).

However, a process of making the polarizing plate including the polarizer and the protective layer is complicated and expensive, and also results in a thick polarizing plate which leads to an increased thickness of a display device.

Accordingly, there is an unmet need in obtaining a polarizing film that does not require a protective layer.

### SUMMARY

an embodiment provides a composition for a polarizing film that may improve polarization properties of the film.

Another embodiment provides a polarizing film that is elongated and includes the composition for a polarizing film.

Yet another embodiment provides a display device including the polarizing film.

According to an embodiment, provided is a composition for a polarizing film that includes a polymer, a dichroic dye, and a liquid crystal oligomer, wherein the liquid crystal oligomer includes a mesogen unit and a kink-forming arylene unit.

The liquid crystal oligomer may be represented by the following Chemical Formula 1.

T₁-L₁-(Ar₁)ₙ-L₂-(Ar₂)ₘ-L₃-T₂ Chemical Formula 1

In Chemical Formula 1,

Ar₁ is the kink-forming arylene unit,

Ar₂ is the mesogen unit,

L₁, L₂, and L₃ are the same or different and are each a linking group,

T₁ and T₂ are each independently a C1 to C20 aromatic or aliphatic group without a hydrophilic functional group, and

n and m are mole ratios wherein 0.05≦n≦10.6 and 0.4≦m≦0.95.

Ar₁ of the Chemical Formula 1 may be represented by the following Chemical Formula 2.

—[X₁-A₁-Y₁]— Chemical Formula 2

In Chemical Formula 2,

A₁ is an arylene group having a kink structure, and

X₁ and Y₁ are each independently —C(═O)O—, —OC(═O)—, —(C(═O)—, —O—, —C(═N)(R^{a})—, —C(═O)N(R^{b})—, —N(R^{c})—, —N(R^{d})C(═O)—, —C(═O)N(R^{e})—, or a combination thereof, wherein R^{a} to R^{e} are each independently hydrogen, a substituted or unsubstituted C1 to C30 alkyl group, a substituted or unsubstituted C6 to C30 aryl group, or a combination thereof.

A₁ of the Chemical Formula 2 may include at least one selected from Groups 1-1 to 1-6.

Group 1-1

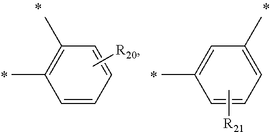

Group 1-2

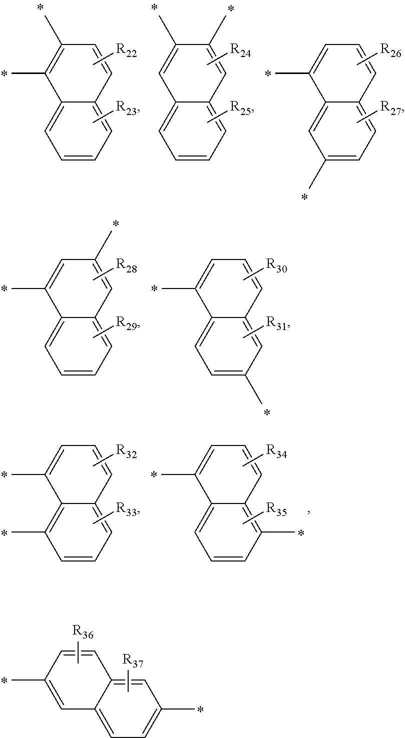

Group 1-3

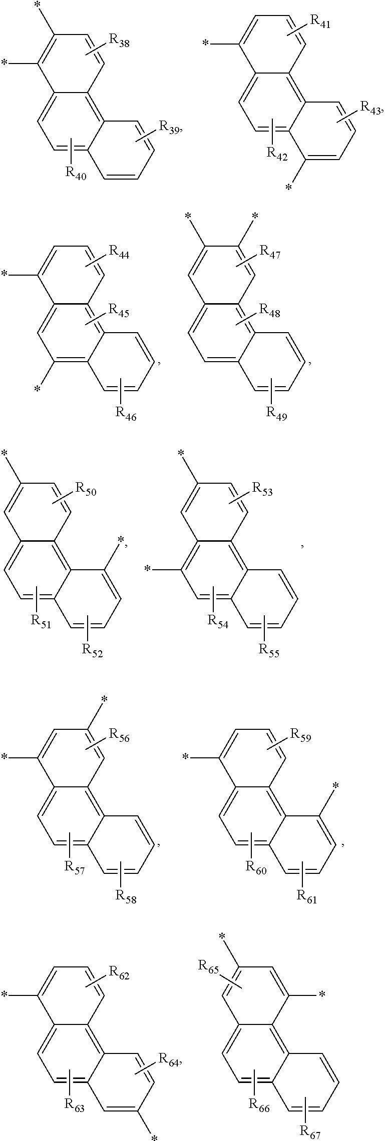

Group 1-4

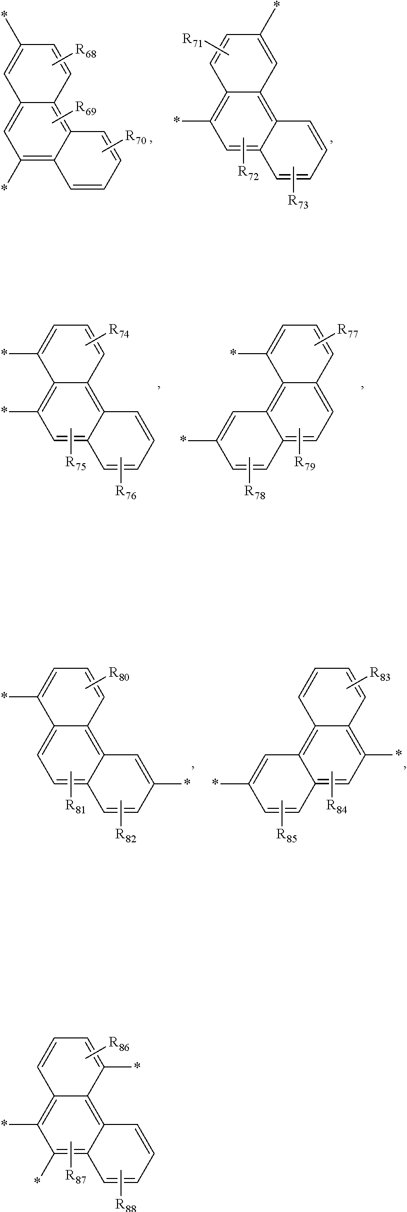

Group 1-5

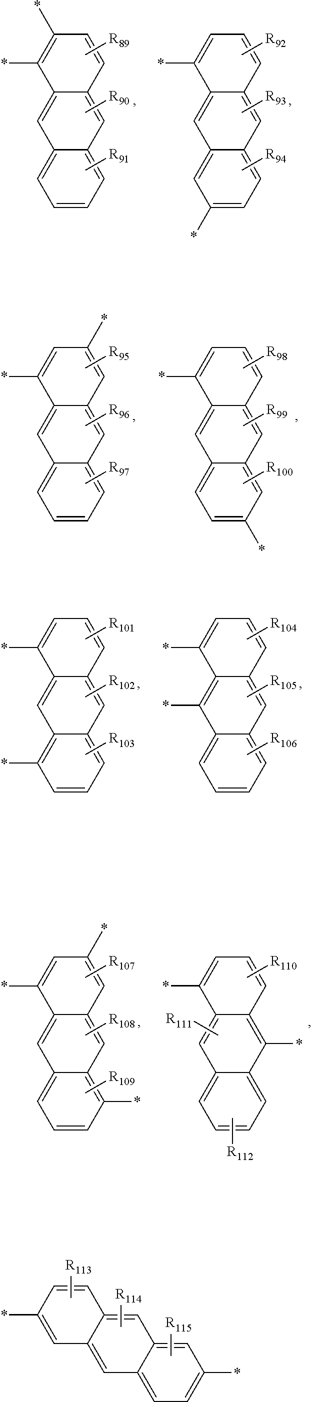

Group 1-6

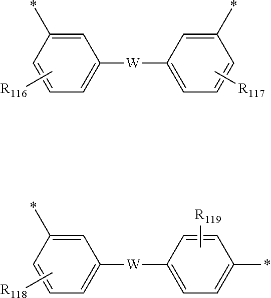

In Groups 1-1 to 1-6,

R₂₀ to R₁₁₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C3 to C30 cycloalkenyl group, a substituted or unsubstituted C7 to C20 arylalkyl group, a substituted or unsubstituted C1 to C20 heteroalkyl group, a substituted or unsubstituted C2 to C30 heterocycloalkyl group, a substituted or unsubstituted C2 to C30 heteroaryl group, a substituted or unsubstituted C2 to C30 alkenyl group, a substituted or unsubstituted C2 to C30 alkynyl group, a substituted or unsubstituted C1 to C20 acyl group, a substituted or unsubstituted amino group, a halogen atom, a halogen-containing group, or a combination thereof, and

W is a single bond, —O—, —C(═O)—, —S—, —SO₂—, —N₂—, a substituted or unsubstituted C1 to C20 alkylene group, a substituted or unsubstituted C1 to C20 oxyalkylene group, a substituted or unsubstituted C6 to C30 arylene group, a substituted or unsubstituted C6 to C30 oxyarylene group, a substituted or unsubstituted C6 to C30 heteroarylene group, a substituted or unsubstituted C6 to C30 oxyheteroarylene group, or a combination thereof.

Ar₂ of the Chemical Formula 1 may be represented by the following Chemical Formula 3.

—[X₂-A₂-Y₂]— Chemical Formula 3

In Chemical Formula 3,

A₂ is a group including a substituted or unsubstituted C3 to C30 cycloalkylene group, a substituted or unsubstituted C6 to C30 arylene group, a substituted or unsubstituted C3 to C30 heterocycloalkylene group, a substituted or unsubstituted C3 to C30 heteroarylene group, or a combination thereof, and

X₂ and Y₂ are each independently —O—, —C(═O)—, a substituted or unsubstituted C1 to C30 alkylene group, a substituted or unsubstituted C1 to C30 oxyalkylene group, or a combination thereof.

A₂ of the Chemical Formula 3 may include at least one selected from Group 2.

Group 2

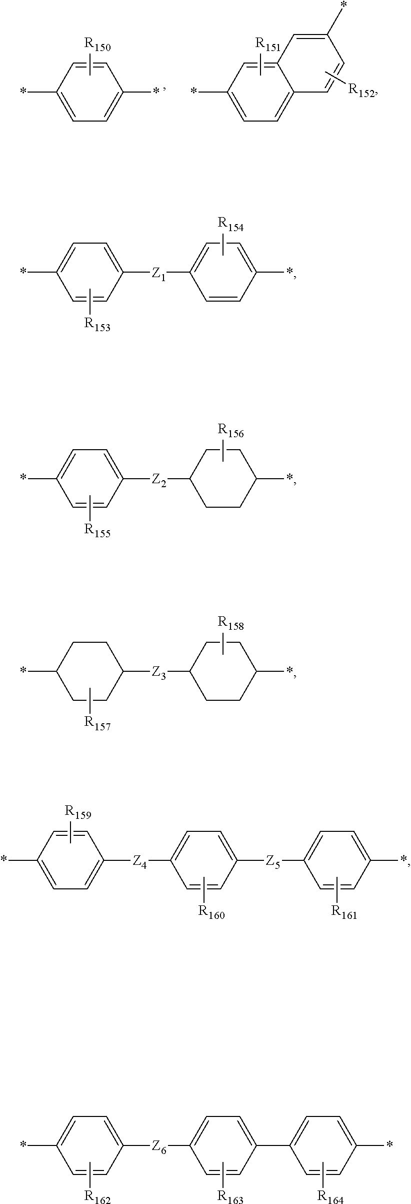

In Group 2,

Z₁ to Z₆ are each independently a single bond, —O—, —C(═O)—, —S—, —SO₂—, —N₂—, a substituted or unsubstituted C1 to C20 alkylene group, a substituted or unsubstituted C1 to C20 oxyalkylene group, a substituted or unsubstituted C6 to C30 arylene group, a substituted or unsubstituted C6 to C30 oxyarylene group, a substituted or unsubstituted C6 to C30 heteroarylene group, a substituted or unsubstituted C6 to C30 oxyheteroarylene group, or a combination thereof, and

R₁₅₀ to R₁₆₄ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C3 to C30 cycloalkenyl group, a substituted or unsubstituted C7 to C20 arylalkyl group, a substituted or unsubstituted C1 to C20 heteroalkyl group, a substituted or unsubstituted C2 to C30 heterocycloalkyl group, a substituted or unsubstituted C2 to C30 heteroaryl group, a substituted or unsubstituted C2 to C30 alkenyl group, a substituted or unsubstituted C2 to C30 alkynyl group, a substituted or unsubstituted C1 to C20 acyl group, a substituted or unsubstituted amino group, a halogen atom, a halogen-containing group, or a combination thereof.

A₂ of the Chemical Formula 1 may be represented by the following Chemical Formula 3a.

—[X₂₁-A₂₁-Y₂₁]ₖ₁—[X₂₂-A₂₂-Y₂₂]ₖ₂—[X₂₃-A₂₃-Y₂₃]ₖ₃—[X₂₄-A₂₄-Y₂₄]ₖ₄— Chemical Formula 3a

In Chemical Formula 3a,

A₂₁, A₂₂, A₂₃, and A₂₄ are each independently a group including a substituted or unsubstituted C3 to C30 cycloalkylene group, a substituted or unsubstituted C6 to C30 arylene group, a substituted or unsubstituted C3 to C30 heterocycloalkylene group, a substituted or unsubstituted C3 to C30 heteroarylene group, or a combination thereof,

X₂₁, X₂₂, X₂₃, X₂₄, Y₂₁, Y₂₂, Y₂₃, and Y₂₄ are each independently —O—, —C(═O)—, a substituted or unsubstituted C1 to C20 alkylene group, a substituted or unsubstituted C1 to C20 oxyalkylene group, or a combination thereof,

k₁ to k₄ are each independently 0 to 50, and

at least one of k₁ to k₄ is not 0.

T₁ and T₂ of the Chemical Formula 1 are each independently at least one of Chemical Formulae 4-1 to 4-12.

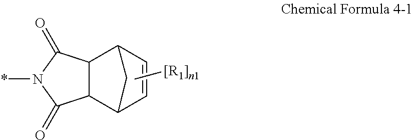

In Chemical Formula 4-1,

n₁ is an integer ranging from 0 to 6,

R₁ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁ is 2 or more, the substituents are the same or different.

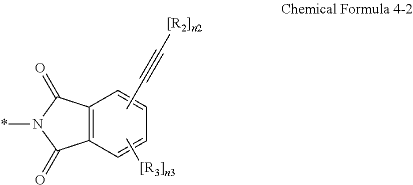

In Chemical Formula 4-2,

n₂ is 1, n₃ is an integer ranging from 0 to 3,

R₂ is a substituent selected from hydrogen, a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group; and

R₃ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₃ is 2 or more, the substituents are the same or different.

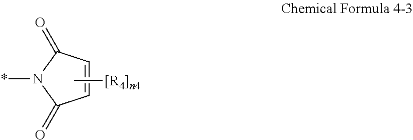

In Chemical Formula 4-3,

n₄ is an integer ranging from 0 to 2,

R₄ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₄ is 2, the substituents are the same or different.

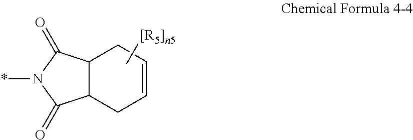

In Chemical Formula 4-4,

n₅ is an integer ranging from 0 to 8,

R₅ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₅ is 2 or more, the substituents are the same or different.

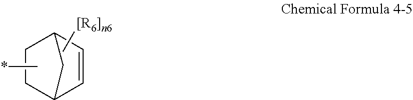

In Chemical Formula 4-5,

n₆ is an integer ranging from 0 to 7,

R₆ is a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₆ is 2 or more, the substituents are the same or different.

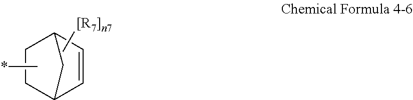

In Chemical Formula 4-6,

n₇ is an integer ranging from 0 to 9,

R₇ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group and when n₇ is 2 or more, the substituents are the same or different.

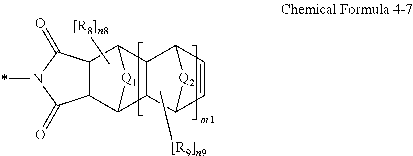

In Chemical Formula 4-7,

m₁ is an integer ranging from 1 to 3,

n₈ and n₉ are each independently integers ranging from 0 to 6,

R₈ and R₉ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₈ and n₉ are 2 or more, the substituents are the same or different, and

Q₁ and Q₂ are each independently a methylene group, —O—, or —S—,

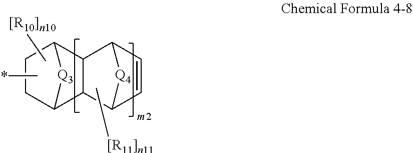

In Chemical Formula 4-8,

m₂ is an integer ranging from 1 to 3,

n₁₀ is an integer ranging from 0 to 7, n₁₁ is an integer ranging from 0 to 6,

R₁₀ and R₁₁ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁₀ and n₁₁ are 2 or more, the substituents are the same or different, and

Q₃ and Q₄ are each independently a methylene group, —O—, or —S—,

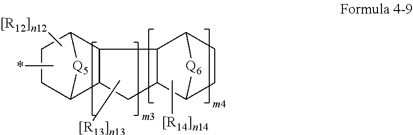

In Chemical Formula 4-9,

m₃ and m₄ are each independently integers ranging from 1 to 3, n₁₂ is an integer ranging from 0 to 7, n₁₃ is an integer ranging from 0 to 6, n₁₄ is an integer ranging from 0 to 8,

R₁₂ to R₁₄ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁₂ and n₁₃ are 2 or more, the substituents are the same or different, and

Q₅ and Q₆ are each independently a methylene group, —O—, or —S—,

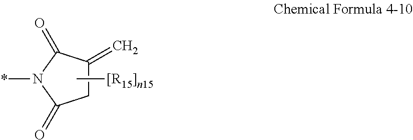

In Chemical Formula 4-10,

n₁₅ is an integer ranging from 0 to 2,

R₁₅ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁₅ is 2, the substituents are the same or different.

*—C≡CH Chemical Formula 4-11

*—C≡N Chemical Formula 4-12

The liquid crystal oligomer may have a melting point of less than or equal to about 250° C.

The liquid crystal oligomer may have a solubility parameter of about 15 to about 30.

The polymer may include at least one of polyolefin, polyethylene terephthalate (“PET”), glycol modified polyethylene terephthalate (“PETG”), polyester, nylon, copolymers thereof, and a combination thereof.

The solubility parameter difference between the polymer and the dichroic dye may be less than 7.4.

The polymer may be the polyolefin, and the dichroic dye may be represented by the Chemical Formula 1

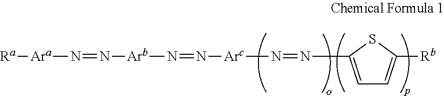

wherein, in Chemical Formula 1,

Ar^{a} to Ar^{c} are each independently a substituted or unsubstituted C6 to C15 arylene group,

R^{a} and R^{b} are each independently a substituted or unsubstituted C1 to C30 aliphatic group, a substituted or unsubstituted C3 to C8 cycloaliphatic group, a substituted or unsubstituted C6 to C30 aromatic group, a substituted or unsubstituted C1 to C30 hetero aliphatic group, a substituted or unsubstituted C1 to C30 hetero aromatic group, or a combination thereof, and

o and p are independently 0 or 1.

R^{a} may be a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and R^{b} may be a substituted or unsubstituted C1 to C30 alkyl group, a substituted or unsubstituted C6 to C20 aryl group, a substituted or unsubstituted C1 to C20 alkoxy group, a substituted or unsubstituted C1 to C20 thioalkyl group, —NRcRd, or a combination thereof, wherein Rc and Rd are each independently hydrogen, a substituted or unsubstituted C1 to C10 alkyl group or are linked to each other to form a ring.

When each of o and p is 1, R^{a} may be a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and R^{b} may be a substituted or unsubstituted C1 to C30 alkyl group, a substituted or unsubstituted C6 to C20 aryl group, —NR^{c}R^{d}, or a combination thereof, wherein R^{c} and R^{d} are each independently hydrogen, a substituted or unsubstituted C1 to C10 alkyl group, or are linked to each other to form a ring.

When each of o and p is 0, R^{a} may be a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and R^{b} may be a substituted or unsubstituted C1 to C30 alkyl group, —NR^{c}R^{d}, or a combination thereof, wherein R^{c} and R^{d} are each independently hydrogen, a substituted or unsubstituted C1 to C10 alkyl group, or are linked to each other to form a ring.

wherein when o is 1 and p is 0, R^{a} may be a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and R^{b} may be a substituted or unsubstituted C1 to C30 alkyl group, a substituted or unsubstituted C6 to 030 aryl group, —NR^{c}R^{d}, or a combination thereof, wherein R^{c} and R^{d} are each independently hydrogen, a substituted or unsubstituted C1 to C10 alkyl group, or are linked to each other to form a ring.

The liquid crystal oligomer and the dichroic dye may be included in an amount of about 0.01 to 10 parts by weight and about 0.05 to about 5 parts by weight based on a total of 100 parts by weight of the polymer.

According to another embodiment, a uniaxially elongated polarizing film including the composition for a polarizing film is provided.

According to yet another embodiment, a display device including the polarizing film is provided.

### BRIEF DESCRIPTION OF THE DRAWINGS

FIG. 1 is schematic view of a polarizing film according to an embodiment.

FIG. 2 is a cross-sectional view showing a liquid crystal display (“LCD”) according to an embodiment.

FIG. 3 is a graph of polarizing efficiency of polarizing films (percent, %) versus film elongation ratio (percent, %), according to Examples 1-1 and 1-2 and Comparative Example 1.

FIG. 4 is a graph of absorbance of polarizing films versus wavelength (nanometer, nm), according to Example 2 and Comparative Example 2 in a wavelength region of 380 to 780 nm.

FIG. 5 is a graph showing a dichroic ratio of polarizing films versus wavelength (nanometer, nm), according to Example 2 and Comparative Example 2.

### DETAILED DESCRIPTION

This disclosure will be described more fully hereinafter with reference to the accompanying drawings, in which exemplary embodiments of the present invention are shown. This disclosure may, however, be embodied in many different forms and should not be construed as limited to the exemplary embodiments set forth herein. Accordingly, the embodiments are merely described below, by referring to the figures, to explain aspects of the present description. As used herein, the term “and/or” includes any and all combinations of one or more of the associated listed items.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, when a definition is not otherwise provided, the term “substituted” refers to one substituted with at least one substituent selected from a halogen atom (F, Br, Cl, or I), a hydroxyl group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, and a combination thereof, in place of at least one hydrogen of a compound.

Substituents in the formulae of this application may be defined as follows.

As used herein, the term “alkyl” indicates a completely saturated, branched or unbranched (or a straight or linear) hydrocarbon.

Non-limiting examples of the “alkyl” group are methyl, ethyl, n-propyl, iso-propyl, n-butyl, iso-butyl, sec-butyl, t-butyl, iso-pentyl, neo-pentyl, iso-amyl, n-hexyl, 3-methylhexyl, 2,2-dimethylpentyl, 2,3-dimethylpentyl, and n-heptyl.

At least one hydrogen atom of the alkyl group may be substituted with a halogen atom, a C1-C20 alkyl group substituted with a halogen atom (for example, CCF₃, CHCF₂, CH₂F, CCl₃, and the like), a C1-C20 alkoxy group, a C2-C20 alkoxyalkyl group, a hydroxyl group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, a phosphoric acid or a salt thereof, a C1-C20 alkyl group, a C2-C20 alkenyl group, a C2-C20 alkynyl group, a C1-C20 heteroalkyl group, a C6-C20 aryl group, a C6-C20 arylalkyl group, a C6-C20 heteroaryl group, a C7-C20 heteroarylalkyl group, a C6-C20 heteroaryloxy group, a C6-C20 heteroaryloxyalkyl group, or a C6-C20 heteroarylalkyl group.

A “heteroalkyl” group is an alkyl group that comprises at least one heteroatom covalently bonded to one or more carbon atoms of the alkyl group. Each heteroatom is independently chosen from nitrogen (N), oxygen (O), sulfur (S), and phosphorus (P).

As used herein, the term “cycloalkyl” indicates a monovalent group having one or more saturated rings in which all ring members are carbon (e.g., cyclopentyl and cyclohexyl).

A “heterocycloalkyl” group is an alkyl group that comprises at least one heteroatom covalently bonded to one or more carbon atoms of the cycloalkyl group. Each heteroatom is independently chosen from nitrogen (N), oxygen (O), sulfur (S), and phosphorus (P).

As used herein, the term “alkoxy” indicates “alkyl-O—”, wherein the term “alkyl” has the same meaning as described above. Non-limiting examples of the alkoxy group are methoxy, ethoxy, n-propoxy, 2-propoxy, n-butoxy, sec-butoxy, t-butoxy, pentyloxy, hexyloxy, cyclopropoxy, and cyclohexyloxy. At least one hydrogen atom of the alkoxy group may be substituted with substituents that are the same as those described above in conjunction with the alkyl group.

As used herein, the term “alkoxyalkyl” indicates an alkyl group with a substituent that is the same as that described above in conjunction with the alkoxy group. At least one hydrogen atom of the alkoxyalkyl group may be substituted with substituents that are the same as those described above in conjunction with the alkyl group. As defined above, the term “alkoxyalkyl” refers to substituted alkoxyalkyl moieties.

The term “halogen atom” indicates fluorine, bromine, chloride, iodine, and the like.

As used herein, the term “halogen containing group” indicates a structural moiety substituted with one or more halogen atoms.

As used herein, the term “alkenyl” indicates a branched or unbranched hydrocarbon with at least one carbon-carbon double bond. Non-limiting examples of the alkenyl group are vinyl, aryl, n-butenyl, iso-propenyl, and iso-butenyl. At least one hydrogen atom in the alkenyl group may be substituted with a substituent that is the same as that described above in conjunction with the alkyl group.

As used herein, the term “cycloalkenyl” indicates a cycloalkane with at least on carbon-carbon double bond. Non-limiting examples of the cycloalkenyl group are cyclobutenyl, cyclopentenyl, cyclopentanedienyl, cyclohexenyl, cyclohexanedienyl.

As used herein, the term “alkynyl” indicated a branched or unbranched hydrocarbon with at least one carbon-carbon triple bond. Non-limiting examples of the “alkynyl” group are ethynyl, n-butynyl, iso-butynyl, and iso-propynyl.

The term “acyl”, as used herein, alone or in combination, refers to a carbonyl attached to an alkenyl, alkyl, aryl, cycloalkyl, heteroaryl, heterocyclyl, or any other moiety where the atom attached to the carbonyl is carbon. Non-limiting examples of acyl groups are acetyl group [—C(═O)CH₃], propionyl group [—C(═O)CH₂CH₃], and benzoyl group [(—C(═O)C₆H₅].

As used herein, the term “aryl” group, which is used alone or in combination, indicates an aromatic hydrocarbon containing at least one ring.

The term “aryl” is construed as including a group with an aromatic ring fused to at least one cycloalkyl ring.

Non-limiting examples of the “aryl” group are phenyl, naphthyl, and tetrahydronaphthyl.

At least one hydrogen atom in the aryl group may be substituted with the same substituent as described above in conjunction with the alkyl group.

The term “arylalkyl” indicates an alkyl group substituted with an aryl group. Non-limiting examples of the “arylalkyl” group include benzyl and phenyl (—CH₂CH₂—).

As used herein, the term “heteroaryl group” indicates a monocyclic or bicyclic organic compound including at least one heteroatom selected from nitrogen (N), oxygen (O), phosphorous (P), and sulfur (S), wherein the rest of the cyclic atoms are all carbon. The heteroaryl group may include, for example, one to five heteroatoms, and in some embodiments, may include a five- to ten-membered ring.

In the heteroaryl group, S or N may be present in various oxidized forms.

Non-limiting examples of the monocyclic heteroaryl group are thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiaxolyl, 1,2,3-thiadiazolyl, 1,2,4-thiadiazolyl, 1,2,5-thiadiazolyl, 1,3,4-thiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, and 5-pyrimidin-2-yl.

The term “heteroaryl” indicates a heteroaromatic ring fused to at least one of an aryl group, a cycloaliphatic group, and a heterocyclic group.

Non-limiting examples of the bicyclic heteroaryl group are indolyl, isoindolyl, indazolyl, indolizinyl, purinyl, quinolizinyl, quinolinyl, isoquinolinyl, cinnolinyl, phthalazinyl, naphthyridinyl, quinazolinyl, quinaxalinyl, phenanthridinyl, phenathrolinyl, phenazinyl, phenothiazinyl, phenoxazinyl, benzisoqinolinyl, thieno[2,3-b]furanyl, furo[3,2-b]-pyranyl, 5H-pyrido[2,3-d]-o-oxazinyl, 1H-pyrazolo[4,3-d]-oxazolyl, 4H-imidazo[4,5-d]thiazolyl, pyrazino[2,3-d]pyridazinyl, imidazo[2,1-b]thiazolyl, imidazo[1,2-b][1,2,4]triazinyl, 7-benzo[b]thienyl, benzoxazolyl, benzimidazolyl, benzothiazolyl, benzoxapinyl, benzoxazinyl, 1H-pyrrolo[1,2-b][2]benzazapinyl, benzofuryl, benzothiophenyl, benzotriazolyl, pyrrolo[2,3-b]pyridinyl, pyrrolo[3,2-c]pyridinyl, pyrrolo[3,2-b]pyridinyl, imidazo[4,5-b]pyridinyl, imidazo[4,5-c]pyridinyl, pyrazolo[4,3-d]pyridinyl, pyrazolo[4,3-c]pyridinyl, pyrazolo[3,4-c]pyridinyl, pyrazolo[3,4-d]pyridinyl, pyrazolo[3,4-b]pyridinyl, imidazo[1,2-a]pyridinyl, pyrazolo[1,5-a]pyridinyl, pyrrolo[1,2-b]pyridazinyl, imidazo[1,2-c]pyrimidinyl, pyrido[3,2-d]pyrimidinyl, pyrido[4,3-d]pyrimidinyl, pyrido[3,4-d]pyrimidinyl, pyrido[2,3-d]pyrimidinyl, pyrido[2,3-b]pyrazinyl, pyrido[3,4-b]pyrazinyl, pyrimido[5,4-d]pyrimidinyl, pyrazino[2,3-b]pyrazinyl, and pyrimido[4,5-d]pyrimidinyl.

At least one hydrogen atom of the heteroaryl group may be substituted with the same substituent as described above in conjunction with the alkyl group.

The terms “alkylene”, “alkoxyalkylene”, “arylene”, “oxyarylene”, “heteroarylene”, and “oxyheteroarylene” are respectively defined to be same as the monovalent “alkyl”, “alkoxyalkyl”, “aryl”, “oxyaryl”, “heteroaryl” and “oxyheteroaryl” described above, except that they are divalent groups.

At least one hydrogen atom of the respective “alkylene”, “alkoxyalkylene”, “arylene”, “oxyarylene”, “heteroarylene” and “oxyheteroarylene” groups may be substituted with substituents that are the same as those described above in conjunction with the alkyl group.

As used herein, the term “oxyalkylene” refers to an alkylene moiety containing at least one oxygen atom instead of a methylene (CH₂) unit.

As used herein, the term “oxyarylene” refers to the moiety “O-arylene”.

As used herein, the term “oxyheteroarylene” refers to the moiety “O-heteroarylene”.

As used herein, when a definition is not otherwise provided, the term “hetero” refers to one including 1 to 3 heteroatoms of nitrogen (N), oxygen (O), sulfur (S), or phosphorus (P).

Hereinafter, a composition for a polarizing film according to an embodiment is described.

The composition for a polarizing film according to an embodiment includes a polymer, a dichroic dye, and a liquid crystal oligomer.

The polymer may be any transparent polymer being capable of transmitting light without limitation. The polymer may, for example, be a polyester such as polyethylene terephthalate (“PET”), glycol modified polyethylene terephthalate (“PETG”), and polyethylene naphthalate; an acryl-based polymer such as polymethyl(meth)acrylate; a styrene-based polymer such as polystyrene (“PS”) and an acrylonitrile-styrene copolymer; a polycarbonate polymer; a polyolefin such as polyethylene (“PE”), polypropylene (“PP”), and a copolymer thereof; a vinyl chloride-based polymer; an amide-based polymer such as nylon and an aromatic polyamide; an imide-based polymer; a sulfone-based polymer; a polyether sulfone-based polymer; a polyether-etherketone-based polymer; a polyphenylene sulfide-based polymer; a vinyl alcohol-based polymer; a vinylidene chloride-based polymer; a vinyl butyral-based polymer; an allylate-based polymer; a polyoxymethylene-based polymer; an epoxy-based polymer; or a combination thereof.

The polymer may, for example, be at least one selected from polyolefin, polyester such as polyethylene terephthalate (PET) and polyethylene naphthalate (“PEN”), glycol modified polyethylene terephthalate (PETG), nylon, a copolymer thereof, and a combination thereof. The polyolefin may, for example, be polyethylene (PE), polypropylene (PP), polyethylene-polypropylene copolymer (PE-PP), or a combination thereof. The polyolefin may, for example, be a combination of polypropylene (PP) and polyethylene-polypropylene (PE-PP).

The polymer may have an average light transmittance ratio of greater than or equal to about 85% in a visible ray wavelength region and a crystallinity of less than or equal to about 60%, for example about 20% to about 60%.

The polypropylene (PP) may have a melt flow index (“MFI) of, for example about 0.1 g/10 min to about 5 g/10 min. Herein, the melt flow index (MFI) denotes the amount of a melt polymer flowing down per 10 minutes and relates to viscosity of the melt polymer. In other words, the smaller melt flow index (MFI) a polymer has, the lower a viscosity it has. When the polypropylene (PP) has a melt flow index (MFI) within the range, properties of a final product as well as workability may be effectively improved. The polypropylene (PP) may have a melt flow index (MFI) of about 0.5 g/10 min to about 5 g/10 min.

The polyethylene-polypropylene copolymer (PE-PP) may include about 1 wt % to about 50 wt % of an ethylene group based on the total amount of the polyethylene-polypropylene copolymer. When the polyethylene-polypropylene copolymer (PE-PP) has an ethylene group within the range, phase separation of the polypropylene (PP) and the polyethylene-polypropylene copolymer (PE-PP) may be effectively prevented or suppressed. In addition, an elongation rate may be increased, excellent light transmittance may be obtained, and arrangement may also be improved, accomplishing excellent polarization properties. Specifically, the polyethylene-polypropylene copolymer (PE-PP) may include an ethylene group ranging from about 1 wt % to about 25 wt %, about 1 wt % to about 20 wt %, about 1 wt % to about 15 wt %, from about 5 wt % to about 25 wt % based on the total amount of the polyethylene-polypropylene copolymer (PE-PP).

The polyethylene-polypropylene copolymer (PE-PP) may have a melt flow index (MFI) of about 5 g/10 min to about 15 g/10 min. When the polyethylene-polypropylene copolymer (PE-PP) has a melt flow index (MFI) within the range, a property of a final product as well as workability may be effectively improved. The polyethylene-polypropylene copolymer (PE-PP) may have a melt flow index (MFI) of about 10 g/10 min to about 15 g/10 min.

The polyolefin may include the polypropylene (PP) and the polyethylene-polypropylene copolymer (PE-PP) at a weight ratio of about 1:9 to about 9:1. When the polypropylene (PP) and the polyethylene-polypropylene copolymer (PE-PP) are included within the range, not only excellent mechanical strength may be secured but crystallization of the polypropylene may also be prevented, effectively improving haze characteristics. Specifically, the polyolefin may include the polypropylene (PP) and the polyethylene-polypropylene copolymer (PE-PP) in a weight ratio ranging from about 4:6 to about 6:4, and more specifically, about 5:5.

The polyolefin may have a melt flow index (MFI) of about 1 g/10 min to about 15 g/10 min. When the polyolefin has a melt flow index (MFI) within the range, crystals are not excessively formed in the resin. Accordingly, excellent light transmittance as well as appropriate viscosity for fabricating a film may be secured, improving workability. Specifically, the polyolefin may have a melt flow index (MFI) of about 5 g/10 min to about 15 g/10 min.

The polyolefin may have a haze of less than or equal to about 5%. When the polyolefin has a haze within the range, transmittance is increased, securing excellent optical properties. Specifically, the polyolefin may have a haze of less than or equal to about 2% and more specifically, ranging from about 0.5% to about 2%.

The polyolefin may have crystallinity of less than or equal to about 50%. When the polyolefin has crystallinity within the range, the haze of the polyolefin may be decreased, accomplishing excellent optical properties. Specifically, the polyolefin may have crystallinity ranging from about 30% to about 50%.

The dichroic dye is a material having a characteristic of transmitting one polarization orthogonal component of two polarization orthogonal components in a predetermined wavelength region.

The dichroic dye may be dispersed in the polymer and elongated in a uniaxial direction to be arrayed in one direction.

Such a dichroic dye may include, for example, a molecular backbone selected from an azo-based compound, an anthraquinone-based compound, a phthalocyanine-based compound, an azomethine-based compound, an indigoid or thioindigoid-based compound, a merocyanine-based compound, a 1,3-bis(dicyanomethylene)indan)-based compound, an azulene-based compound, a quinophthalonic-based compound, a triphenodioxazine-based compound, an indolo[2,3-b]quinoxaline-based compound, an imidazo[1,2-b]-1,2,4triazine-based compound, a tetrazine-based compound, a benzoquinone-based compound, a naphtoquinone-based compound, or a combination thereof.

The dichroic dye may be selected from compounds having a solubility parameter difference from the polymer of less than or equal to 7.4. The solubility parameter illustrates an interaction degree to which two or more compounds interact. The smaller the solubility parameter difference the compounds have, the larger the interaction the compounds have therebetween, and the larger the solubility parameter difference the compounds have, the smaller the interaction the compounds have therebetween.

The solubility parameter relates to the structure of compounds. The dichroic dye according to an embodiment has a solubility parameter difference with the polymer of less than 7.4. Without wishing to be bound by theory, when the dichroic dye and the polymer have a solubility parameter difference within the range, the polymer and the dichroic dye have high interaction during the fabrication of a polarizing film, and may increase melt-blending property and thus may prevent agglomeration of the dichroic dyes and uniformly disperse the dichroic dye 72 in the polymer.

A Hildebrand solubility parameter is used to calculate compatibility between the dichroic dye and the polymer.

In general, molecules are agglomerated due to composite cohesive energy such as a Van der Waals interaction, dipole moments, and the like. This cohesive energy (“Ecoh”) is internal energy change per mole and may be represented according to the following Relationship Formula 1.

E_{coh}=ΔU=ΔH−R·−ΔT Relationship Formula 1

In Relationship Formula 1, E_{coh} denotes cohesive energy, ΔU denotes an internal energy change amount per mole, ΔH denotes an enthalpy change amount, R denotes a gas constant, and ΔT denotes a temperature change amount. For a small molecule such as a dichroic dye, enthalpy change ΔH is the same as heat of vaporization.

In addition, cohesive energy per unit volume may be defined as cohesive energy density (“CED”). The cohesive energy density (CED) may be expressed according to the following Relationship Formula 2.

CED=(ΔH−RΔT)/Vm Relationship Formula 2

In Relationship Formula 2, CED denotes cohesive energy density, ΔH denotes an enthalpy change amount, R denotes a gas constant, ΔT denotes a temperature change amount, and Vm denotes a mole volume.

The cohesive energy density is used to define a Hildebrand solubility parameter capable of numerically expressing dissolution capability. The solubility parameter may be calculated by using density or mole volume at a predetermined temperature according to the following Relationship Formula 3.

δ=(CED)^{0.5}=(ΣEcohᵢ/ΣVmᵢ)^{0.5} Relationship Formula 3

In Relationship Formula 3, δ denotes a solubility parameter, CED denotes cohesive energy density, Ecohᵢ denotes cohesive energy for a functional group in a molecule, and Vmᵢ denotes a molar volume of the i functional group on the molecule.

The Hildebrand solubility parameter used to design the structure of a dichroic dye may be calculated by group contribution of a molecule.

Table 4 shows group contribution of cohesive energy (Ecoh) and mole volume (“Vm”) used to calculate the solubility parameter of the dichroic dye. (References: Polym. Eng. Sci. 1974, 14, 147; J. Appl. Polym. Sci. 2005, 96, 416.)

For example, the polymer is the polyolefin, particularly a combination of polypropylene (PP) and polyethylene-polypropylene (PE-PP), the polymer may have a solubility parameter of, for example about 15 to about 18.

When the polymer has a solubility parameter within the range, the dichroic dye may be selected from the compounds having a solubility parameter of less than about 24, and the dichroic dye may, for example, include a compound represented by, for example, the following Chemical Formula 1.

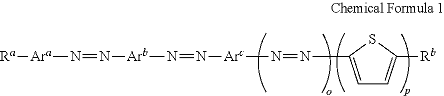

In Chemical Formula 1,

Ar^{a} to Ar^{c} are each independently a substituted or unsubstituted C6 to C15 arylene group,

R^{a} and R^{b} are each independently a substituted or unsubstituted C1 to C30 aliphatic group, a substituted or unsubstituted C3 to C8 cycloaliphatic group, a substituted or unsubstituted C6 to C30 aromatic group, a substituted or unsubstituted C1 to C30 hetero aliphatic group, a substituted or unsubstituted C1 to C30 hetero aromatic group, or a combination thereof, and

o and p are independently 0 or 1.

In Chemical Formula 1, Ar^{a} to Ar^{c} may be each independently, for example, a substituted or unsubstituted phenylene group, a substituted or unsubstituted naphthalene group, or a substituted or unsubstituted biphenylene group. Herein, the substituted phenylene group, the substituted naphthalene group, and the substituted biphenylene group may be substituted with, for example a C1 to C10 alkyl group, a halogen atom, or a combination thereof.

In Chemical Formula 1, R^{a} may be a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and R^{b} may be a substituted or unsubstituted C1 to C30 alkyl group, a substituted or unsubstituted C6 to C20 aryl group, a substituted or unsubstituted C1 to C20 alkoxy group, a substituted or unsubstituted C1 to C20 thioalkyl group, —NR³R⁴, or a combination thereof, wherein R³ and R⁴ may be independently hydrogen, a substituted or unsubstituted C1 to C10 alkyl group, or may be linked to each other to form a ring.

For example, in Chemical Formula 1, when o and p are independently 1, R^{a} may be a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and R^{b} may be a substituted or unsubstituted C1 to C30 alkyl group, a substituted or unsubstituted C6 to C20 aryl group, —NR^{c}R^{d}, or a combination thereof, wherein R^{c} and R^{d} may be independently hydrogen, a substituted or unsubstituted C1 to C10 alkyl group, or may be linked to each other to form a ring.

In another embodiment, when n and m are 1,

R^{a} is a substituted or unsubstituted C1 to C20 alkoxy group or a substituted or unsubstituted C1 to C20 thioalkyl group, and

R^{b} is —NR^{c}R^{d}, wherein R^{c} and R^{d} are each independently hydrogen, substituted or unsubstituted C1 to C10 alkyl group, or are linked to each other to form a ring.

The following Table 1 shows examples of the dichroic dye where o and p are 1.

TABLE 1

| | | Solubility |
|---|---|---|
| No. | COMPOUND | parameter |
| 1-1-1 | 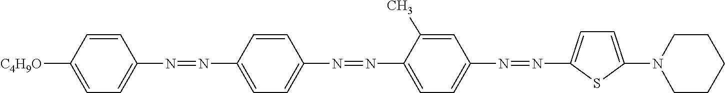 | 22.6 |
| 1-1-2 | 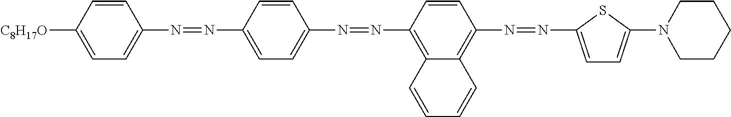 | 23.3 |
| 1-1-3 | 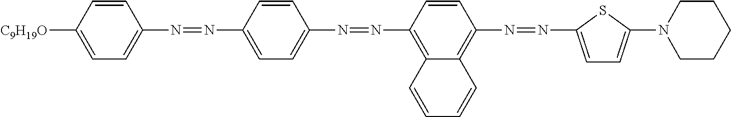 | 23.1 |
| 1-1-4 | 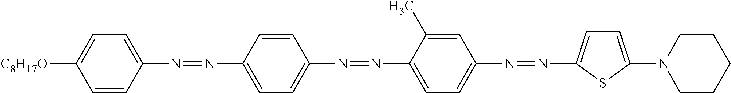 | 21.9 |
| 1-1-5 | 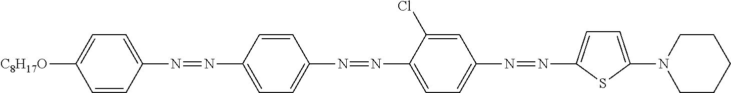 | 22.5 |
| 1-1-6 | 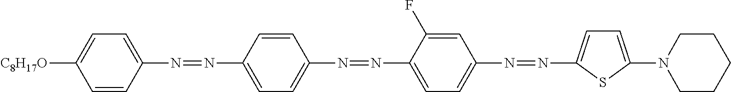 | 22.3 |
| 1-1-7 | 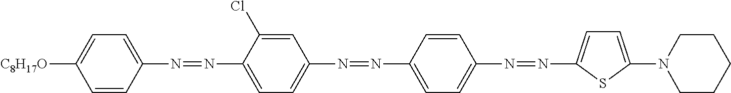 | 22.5 |
| 1-1-8 | 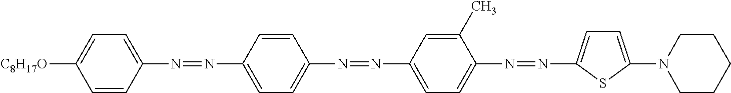 | 21.9 |
| 1-1-9 | 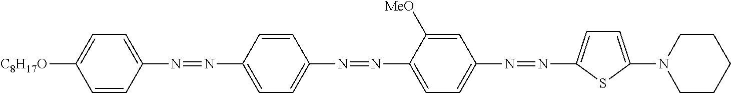 | 22.0 |
| 1-1-10 | 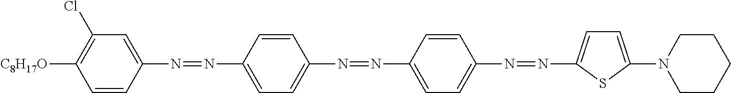 | 22.5 |
| 1-1-11 | 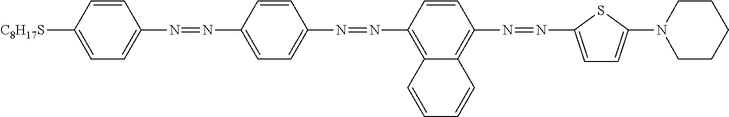 | 23.6 |
| 1-1-12 | 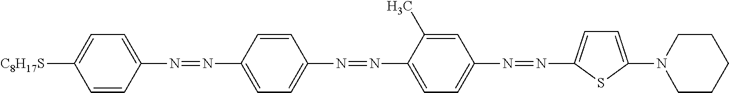 | 22.3 |

For example, in Chemical Formula 1, when n and m are independently 0, R^{a} may be a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and R^{b} may be a substituted or unsubstituted C1 to C30 alkyl group, —NR^{c}R^{d}, or a combination thereof, wherein R^{c} and R^{d} may be independently hydrogen, a substituted or unsubstituted C1 to C10 alkyl group, or may be linked to each other to form a ring.

In another embodiment, when n and m are 0, R^{a} may be a substituted or unsubstituted C1 to C20 alkoxy group, a substituted or unsubstituted C1 to C20 thioalkyl group, or a substituted or unsubstituted C1 to C30 alkyl group, and R^{b} may be hydrogen, a substituted or unsubstituted C1 to C30 alkyl group or —NR^{c}R^{d}, wherein R^{c} and R^{d} are each independently hydrogen, substituted or unsubstituted C1 to C10 alkyl group, or are linked to each other to form a ring.

The following Table 2 shows examples of the dichroic dye where o and p are 0.

TABLE 2

| | | Solubility |
|---|---|---|
| No. | COMPOUND | parameter |
| 1-2-1 | 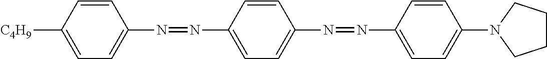 | 21.9 |
| 1-2-2 | 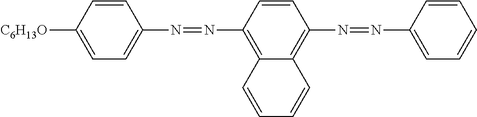 | 23.4 |
| 1-2-3 | 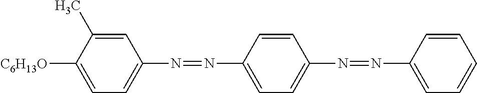 | 21.4 |
| 1-2-4 | 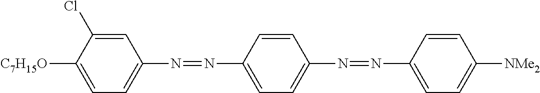 | 21.7 |
| 1-2-5 | 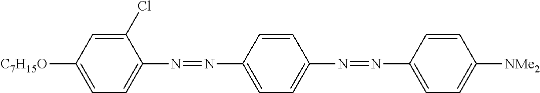 | 21.7 |
| 1-2-6 | 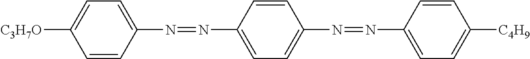 | 21.4 |

For example, in Chemical Formula 1, when o is 1 and p is 0, R^{a} may be a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and R^{b} may be a substituted or unsubstituted C1 to C30 alkyl group, a substituted or unsubstituted C6 to 030 aryl group, —NR^{c}R^{d}, or a combination thereof, wherein R^{c} and R^{d} may be independently hydrogen, a substituted or unsubstituted C1 to C10 alkyl group, or may be linked to each other to form a ring.

In another embodiment, when o is 1 and p is 0, R^{a} is a substituted or unsubstituted C1 to C20 alkoxy group, a substituted or unsubstituted C1 to C20 thioalkyl group, or a substituted or unsubstituted C1 to C30 alkyl group, and R^{b} is a substituted or unsubstituted C6 to C30 aryl group.

The following Table 3 shows examples of the dichroic dye wherein o is 1 and p is 0.

TABLE 3

| | | Solubility |
|---|---|---|
| No. | COMPOUND | parameter |
| 1-3-1 | 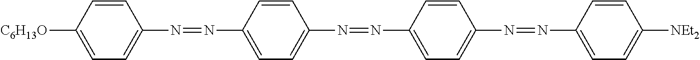 | 21.7 |
| 1-3-2 | 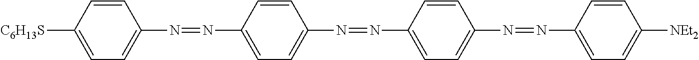 | 22.1 |
| 1-3-3 | 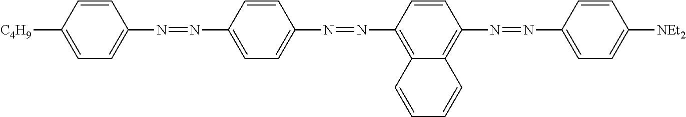 | 23.1 |
| 1-3-4 | 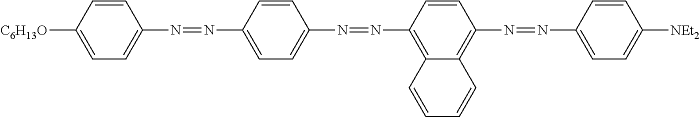 | 23.0 |
| 1-3-5 | 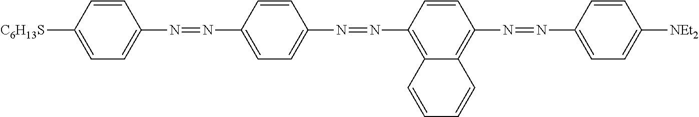 | 23.3 |
| 1-3-6 | 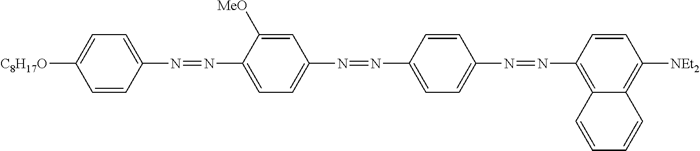 | 22.6 |

The dichroic dye may have a dichroic ratio ranging from about 1.5 to about 14, specifically, from about 3 to about 12, more specifically, from about 5 to about 10. Herein, the dichroic ratio is a value obtained by dividing polarization absorption in a direction parallel to the polymer by polarization absorption in a direction perpendicular to the polymer.

The dichroic ratio may indicate the extent of the dichroic dye arrayed in parallel in one direction. When the dichroic ratio is in the foregoing range, the dichroic dye may have sufficient compatibility with the polymer, thus making melt blending possible, and inducing the orientation of the polymer chain.

The dichroic dye may have a decomposition temperature of greater than or equal to about 245° C. Herein, the decomposition temperature denotes a temperature at which the dichroic dye has about 5% less weight than the initial weight thereof.

The dichroic dye may be included in an amount of about 0.05 to about 5 parts by weight based on a total of 100 parts by weight of the polymer. When the amount of the dichroic dye is in the foregoing range, sufficient polarization characteristics of the dichroic dye may be obtained. According to an embodiment, the dichroic dye may be included in an amount of about 0.05 to 1.5 parts by weight, specifically about 0.05 to about 1 part by weight based on a total of 100 parts by weight of the polymer.

The liquid crystal oligomer may have a shape of a rigid rod extending in one direction, and may induce the elongated alignment in one direction of dichroic dye by melting and blending with the dichroic dye in the polymer. Thereby, the elongation aligning properties of the dichroic dye in such a polymer are increased, and its polarization properties are improved.

The liquid crystal oligomer has a mesogen unit and a kink-forming arylene unit.

The mesogen unit is a unit maintaining the rigid rod shape of the liquid crystal oligomer, and may show a liquid crystal property such as thermotropicity.

The kink-forming arylene unit refers to a unit including an arylene group having a kink structure, and the kink-forming arylene unit has a structure wherein two connection parts of the arylene group are not on the same line. For example, in a case of phenylene, the arylene group having a kink structure includes meta-phenylene (m-phenylene) and ortho-phenylene (o-phenylene) wherein the two connection parts are not on the same line, but the para-phenylene (p-phenylene) wherein two connection parts are on the same line is not included in the arylene group having a kink structure. The arylene group includes all substituted or unsubstituted arylene groups, and for example, may include a C6 to C30 arylene group.

The liquid crystal oligomer may have decreased the melting point as a result of including the kink-forming arylene unit. Accordingly, the liquid crystal oligomer may be melt-blended with the polymer at a melt temperature of the polymer, so that the liquid crystal oligomer may uniformly disperse in the polymer, and thereby the deterioration of transmittance of the polarizing film due to the liquid crystal oligomer may be prevented.

The liquid crystal oligomer may have a melting point such that would allow its melt-blending with the polymer at a processing temperature of the polarizing film. For example, the liquid crystal oligomer may have a melting point of less than or equal to about 250° C., specifically, about 100 to about 250° C.

The liquid crystal oligomer may have a molecular weight of about 500 to about 5,000 Daltons (“Da”), specifically, 1,000 to 5,000 Da. With the molecular weight in the foregoing ranges, the liquid crystal oligomer may be uniformly dispersed in the polymer to induce the alignment of the dichroic dye molecules in one direction.

The liquid crystal oligomer may be represented by the following Chemical Formula 1.

T₁-L₁-(Ar₁)ₙ-L₂-(Ar₂)ₘ-L₃-T₂ Chemical Formula 1

In Chemical Formula 1,

Ar₁ is the substituted kink-forming arylene unit,

Ar₂ is the mesogen unit,

L₁, L₂, and L₃ are the same or different and are each a linking group,

T₁ and T₂ are each independently a C1 to C20 aromatic or aliphatic group without a hydrophilic functional group, for example —OH, —COOH, —NH₂ and the like, and

n and m are mole ratios wherein 0.05≦n≦0.6 and 0.4≦m≦0.95.

Ar₁ of above Chemical Formula 1 may, for example, be represented by the following Chemical Formula 2.

—[X₁-A₁-Y₁]— Chemical Formula 2

In Chemical Formula 2,

A₁ is an arylene group having a kink structure, and

X₁ and Y₁ are each independently —C(═O)O—, —OC(═O)—, —C(═O)—, —O—, —C(═N)(R^{a})—, —C(═O)N(R^{b})—, —N(R^{c})—, —N(R^{d})C(═O)—, —C(═O)N(R^{e})—, or a combination thereof, wherein R^{a} to R^{e} are each independently hydrogen, a substituted or unsubstituted C1 to C30 alkyl group, a substituted or unsubstituted C6 to C30 aryl group, or a combination thereof.

A₁ of the above Chemical Formula 2, the arylene group having a kink structure, may include, for example, at least one selected from Groups 1-1 to 1-6.

Group 1-1

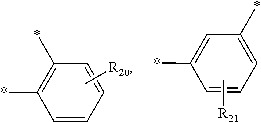

Group 1-2

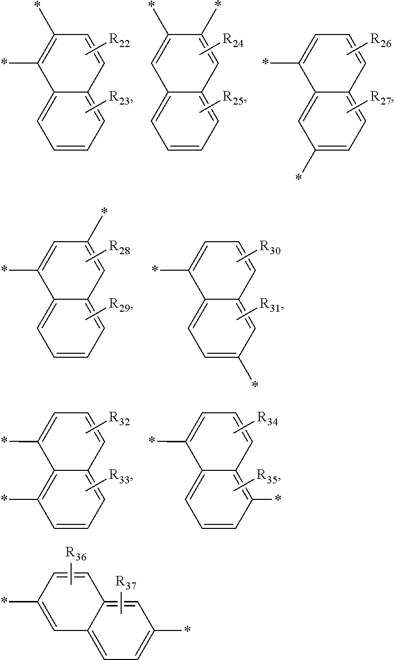

Group 1-3

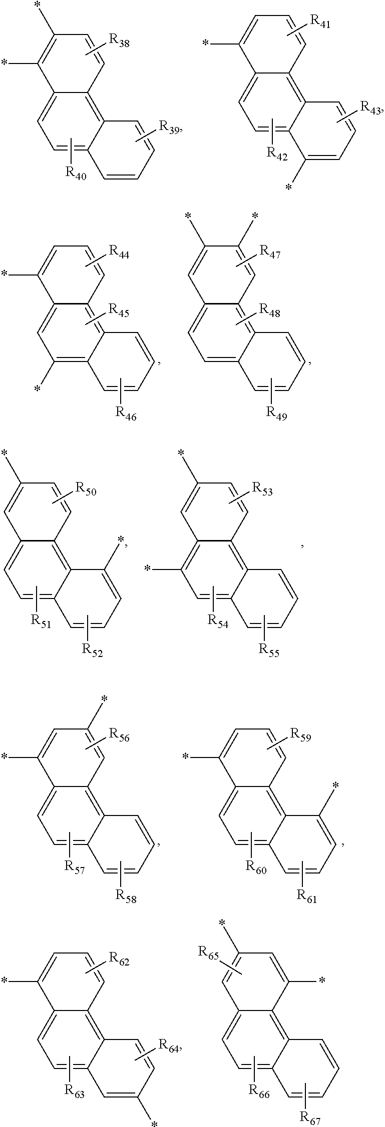

Group 1-4

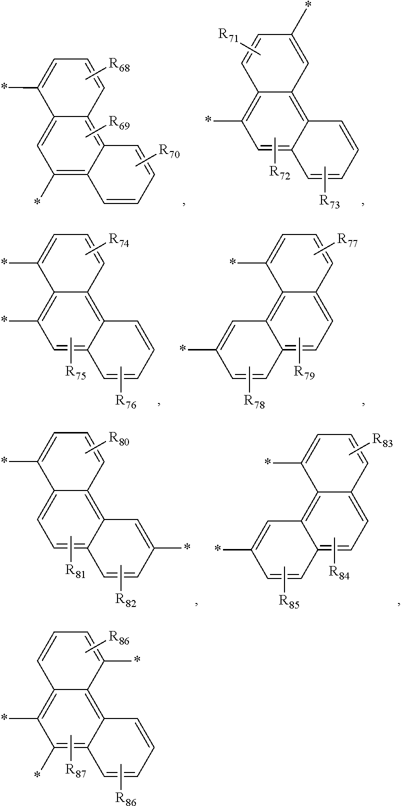

Group 1-5

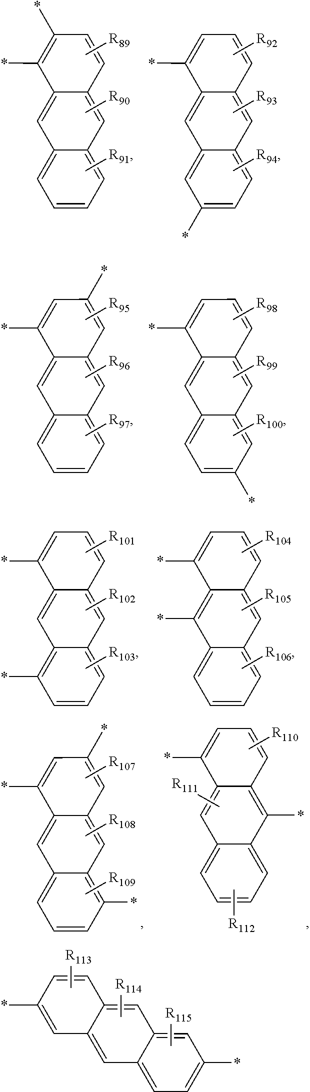

Group 1-6

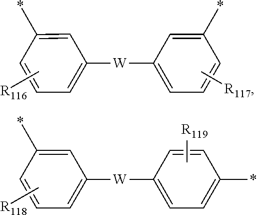

In Groups 1-1 to 1-6,

R₂₀ to R₁₁₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C3 to C30 cycloalkenyl group, a substituted or unsubstituted C7 to C20 arylalkyl group, a substituted or unsubstituted C1 to C20 heteroalkyl group, a substituted or unsubstituted C2 to C30 heterocycloalkyl group, a substituted or unsubstituted C2 to C30 heteroaryl group, a substituted or unsubstituted C2 to C30 alkenyl group, a substituted or unsubstituted C2 to C30 alkynyl group, a substituted or unsubstituted C1 to C20 acyl group, a substituted or unsubstituted amino group, a halogen atom, a halogen-containing group, or a combination thereof, and

W is a single bond, —O—, —C(═O)—, —S—, —SO₂—, —N₂—, a substituted or unsubstituted C1 to C20 alkylene group, a substituted or unsubstituted C1 to C20 oxyalkylene group, a substituted or unsubstituted C6 to C30 arylene group, a substituted or unsubstituted C6 to C30 oxyarylene group, a substituted or unsubstituted C6 to C30 heteroarylene group, a substituted or unsubstituted C6 to C30 oxyheteroarylene group, or a combination thereof.

In Groups 1-1 to 1-6, only one substituent (R₂₀ to R₁₁₉) is shown per each ring, but there may be more than one substituent per one ring. Specifically, each ring may have two or more substituents, and each substituent may be independently selected from the foregoing groups.

Ar₂ of the above Chemical Formula 1, the mesogen group, may include at least one ring, for example, a ring represented by the following Chemical Formula 3.

—[X₂-A₂-Y₂]— Chemical Formula 3

In Chemical Formula 3,

A₂ is a group including a substituted or unsubstituted C3 to C30 cycloalkylene group, a substituted or unsubstituted C6 to C30 arylene group, a substituted or unsubstituted C3 to C30 heterocycloalkylene group, a substituted or unsubstituted C3 to C30 heteroarylene group, or a combination thereof, and

X₂ and Y₂ are each independently —O—, —C(═O)—, a substituted or unsubstituted C1 to C30 alkylene group, a substituted or unsubstituted C1 to C30 oxyalkylene group, or a combination thereof.

A₂ of the above Chemical Formula 3 may include at least one selected from Group 2.

Group 2

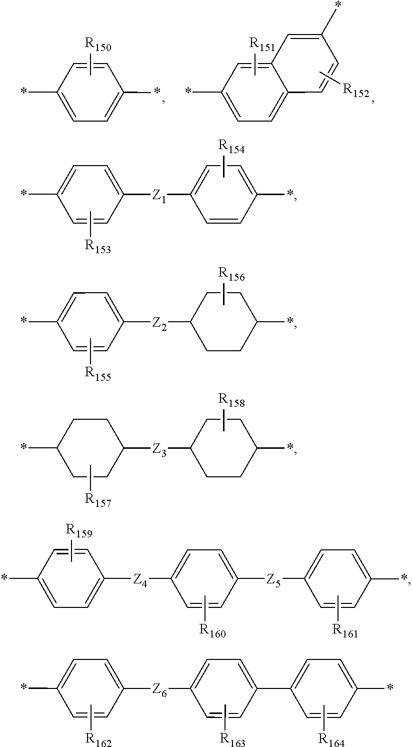

In Group 2,

Z₁ to Z₆ are each independently a single bond, —O—, —C(═O)—, —S—, —SO₂—, —N₂—, a substituted or unsubstituted C1 to C20 alkylene group, a substituted or unsubstituted C1 to C20 oxyalkylene group, a substituted or unsubstituted C6 to C30 arylene group, a substituted or unsubstituted C6 to C30 oxyarylene group, a substituted or unsubstituted C6 to C30 heteroarylene group, a substituted or unsubstituted C6 to C30 oxyheteroarylene group, or a combination thereof, and

R₁₅₀ to R₁₆₄ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C3 to C30 cycloalkenyl group, a substituted or unsubstituted C7 to C20 arylalkyl group, a substituted or unsubstituted C1 to C20 heteroalkyl group, a substituted or unsubstituted C2 to C30 heterocycloalkyl group, a substituted or unsubstituted C2 to C30 heteroaryl group, a substituted or unsubstituted C2 to C30 alkenyl group, a substituted or unsubstituted C2 to C30 alkynyl group, a substituted or unsubstituted C1 to C20 acyl group, a substituted or unsubstituted amino group, a halogen atom, a halogen-containing group, or a combination thereof.

Ar₂ of the above Chemical Formula 1 may have a linked structure including the same or different structures, and may, for example, be represented by the following Chemical Formula 3a.

—[X₂₁-A₂₁-Y₂₁]ₖ₁—[X₂₂-A₂₂-Y₂₂]ₖ₂—[X₂₃-A₂₃-Y₂₃]ₖ₃—[X₂₄-A₂₄-Y₂₄]ₖ₄— Chemical Formula 3a

In Chemical Formula 3a,

A₂₁, A₂₂, A₂₃, and A₂₄ are each independently a substituted or unsubstituted C3 to C30 cycloalkylene group, a substituted or unsubstituted C6 to C30 arylene group, a substituted or unsubstituted C3 to C30 heterocycloalkylene group, a substituted or unsubstituted C3 to C30 heteroarylene group, or a combination thereof,

X₂₁, X₂₂, X₂₃, X₂₄, Y₂₁, Y₂₂, Y₂₃, and Y₂₄ are each independently —O—, —C(═O)—, a substituted or unsubstituted C1 to C20 alkylene group, a substituted or unsubstituted C1 to C20 oxyalkylene group, or a combination thereof,

k₁ to k₄ are each independently 0 to 50, and

at least one of k₁ to k₄ is not 0.

A₂₁, A₂₂, A₂₃, and A₂₄ of the above Chemical Formula 3a are each independently at least one selected from Group 2.

L₁, L₂, and L₃ of the above Chemical Formula 1 are the same or different, and are each a linking group, for example a single bond, a substituted or unsubstituted C1 to C30 alkylene group, a substituted or unsubstituted C3 to C30 cycloalkylene group, a substituted or unsubstituted C6 to C30 arylene group, a substituted or unsubstituted C3 to C30 cycloalkenylene group, a substituted or unsubstituted C7 to C20 arylalkylene group, a substituted or unsubstituted C1 to C20 heteroalkylene group, a substituted or unsubstituted C2 to C30 heterocycloalkylene group, a substituted or unsubstituted C2 to C30 heteroarylene group, a substituted or unsubstituted C2 to C30 alkenylene group, a substituted or unsubstituted C2 to C30 alkynylene group, a substituted or unsubstituted C2 to C30 oxyalkylene group, a substituted or unsubstituted C1 to C30 ester group, a substituted or unsubstituted C1 to C30 ether group, a substituted or unsubstituted amino group, or a combination thereof, but are not limited thereto.

T₁ and T₂ in the above Chemical Formula 1, are each an end capping group, and are each independently a C1 to C20 aromatic or aliphatic group without a hydrophilic functional group such as —OH, —COOH, and —NH₂.

The T₁ and T₂ may each be a hydrophobic functional group having no hydroxy group and/or carboxyl group considering the compatibility with the polymer.

T₁ and T₂ may each independently include, for example, at least one selected from Chemical Formulae 4-1 to 4-12.

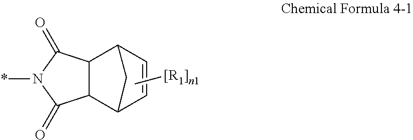

In Chemical Formula 4-1,

n₁ is an integer ranging from 0 to 6,

R₁ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁ is 2 or more, the substituents are the same or different.

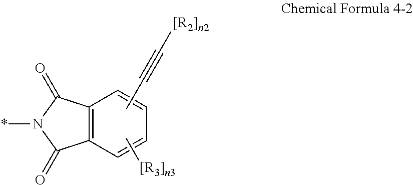

In Chemical Formula 4-2,

n₂ is 1, n₃ is an integer ranging from 0 to 3,

R₂ is a substituent selected from hydrogen, a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and

R₃ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₃ is 2 or more, the substituents are the same or different.

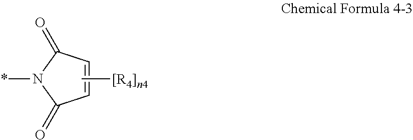

In Chemical Formula 4-3,

n₄ is an integer ranging from 0 to 2,

R₄ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group,

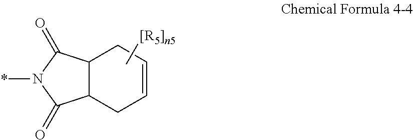

In Chemical Formula 4-4,

n₅ is an integer ranging from 0 to 8,

R₅ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₅ is 2 or more, the substituents are the same or different.

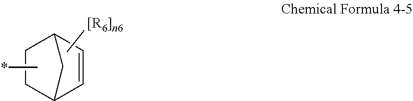

In Chemical Formula 4-5,

n₆ is an integer ranging from 0 to 7,

R₆ is a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₆ is 2 or more, the substituents are the same or different.

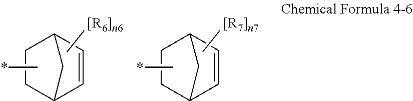

In Chemical Formula 4-6,

n₇ is an integer ranging from 0 to 9,

R₇ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₇ is 2 or more, the substituents are the same or different.

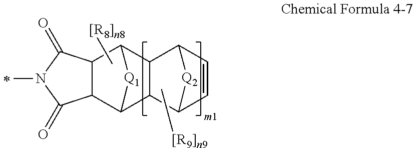

In Chemical Formula 4-7,

m₁ is an integer ranging from 1 to 3,

n₈ and n₉ are each independently integers ranging from 0 to 6, R₈ and R₉ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₈ and n₉ are 2 or more, the substituents are the same or different,

Q₁ and Q₂ are each independently a methylene group, —O—, or —S—,

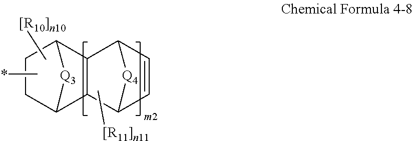

In Chemical Formula 4-8,

m₂ is an integer ranging from 1 to 3,

n₁₀ is an integer ranging from 0 to 7, n₁₁ is an integer ranging from 0 to 6,

R₁₀ and R₁₁ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁₀ and n₁₁ are 2 or more, the substituents are the same or different,

Q₃ and Q₄ are each independently a methylene group, —O—, or —S—,

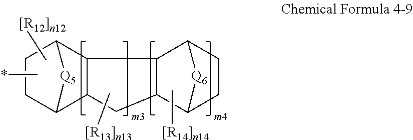

In Chemical Formula 4-9,

m₃ and m₄ are each independently integers ranging from 1 to 3,

n₁₂ is an integer ranging from 0 to 7, n₁₃ is an integer ranging from 0 to 6, n₁₄ is an integer ranging from 0 to 8,

R₁₂ to R₁₄ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁₂ and n₁₃ are 2 or more, the substituents are the same or different,

Q₅ and Q₆ are each independently a methylene group, —O—, or —S—,

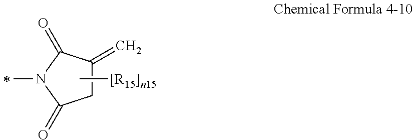

In Chemical Formula 4-10,

n₁₅ is an integer ranging from 0 to 2,

R₁₅ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group,

*—C≡CH Chemical Formula 4-12

*—C≡N Chemical Formula 4-12

As the difference between the solubility parameter of the liquid crystal oligomer and the solubility parameter of the polymer is decreased, the melt-blending becomes easier during the polarizing film processing. For example, the solubility parameter difference may be less than or equal to about 10, specifically, less than or equal to about 5.

The liquid crystal oligomer may have a solubility parameter of about 15 to about 30, and specifically about 18 to about 25. By having the solubility parameter in the foregoing ranges, the excellent melt-blending property with the polymer may be provided.

The liquid crystal oligomer may be included in an amount of about 0.01 to about 10 parts by weight based on a total of 100 parts by weight of the polymer. When included within the foregoing range, the alignment inducing effect of the dichroic dye may be provided without deteriorating transmittance of the polarizing film.

The polymer and the dichroic dye are respectively a solid such as a powder. The composition including the polymer and the dichroic dye may include, for example, a solid content of greater than or equal to about 90 wt %, and for example, not including a solvent.

The composition for a polarizing film may be formed for a polarizing film according to melt-blending and elongating processes.

The polarizing film according to an embodiment may be manufactured by melt-blending the composition for a polarizing film including a polymer, a dichroic dye, and a liquid crystal oligomer at a processing temperature, forming a sheet by putting the molten mixture into a mold, compressing the resultant molten mixture, and uniaxially elongating the sheet using a roll.

The melt-blending may be performed at the processing temperature of, for example, higher than or equal to a melting point of the polymer, for example between higher than or equal to a melting point of the polymer and less than or equal to about 250° C., particularly, about 100 to 250° C.

The forming a sheet may be performed by introducing the molten mixture into the mold and compressing the same using a high-pressure press, or by discharging the same into a chill roll through a T-die.

The uniaxially elongating may be performed at an elongation percentage of about 300% to about 1,000%, specifically about 300% to about 800%. The elongation percentage refers to a ratio of a length after the elongation to a length before the elongation of a sheet and represents the elongation extent of the sheet after uniaxial elongation.

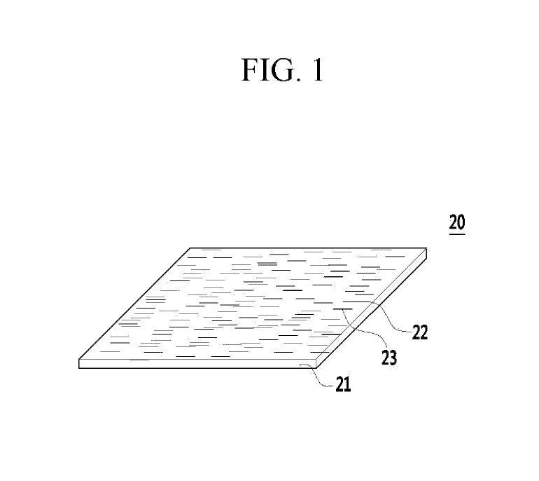

FIG. 1 is schematic view of a polarizing film according to an embodiment.

Referring to FIG. 1, a polarizing film 20 according to an embodiment includes a polymer 21, a dichroic dye 22, and a liquid crystal oligomer 23, and the dichroic dye 22 and the liquid crystal oligomer 23 are uniaxially elongated along one direction in the polymer 21.

A polarizing film 20 may have a dichroic ratio ranging from about 3 to about 10 in a visible ray wavelength region ranging from about 380 nm to about 780 nm. Herein, the dichroic ratio may be calculated by dividing plane polarization absorbance in a vertical direction with the axis of a polymer by polarization absorbance in a horizontal direction according to the following equation 1.

DR=Abs_{∥}/Abs_{⊥} Equation 1

In Equation 1,

DR denotes a dichroic ratio of a polarizing film,

Abs_{∥} is light absorbance of light entering parallel to the transmissive axis of a polarizing film, and

Abs_{⊥} is light absorbance of light entering vertical to the transmissive axis of the polarizing film.

For reference, the light absorbance and light transmittance (T) are co-related by T=10^{-Abs}

The polarization efficiency is obtained according to the following Equation 2.

PE(%)=[(T_{□}−T_{□})/(T_{□}−T_{□})]^{1/2}×100 Equation 2

In Equation 2,

PE denotes polarization efficiency,

T_{ν} is light transmittance for light entering parallel to the transmissive axis of a polarizing film, and

T_{⊥} is light transmittance for light entering perpendicular to the transmissive axis of the polarizing film.

The dichroic ratio shows to what degree the dichroic dyes 22 are arranged in the polarizing film 20 in one direction. When the polarizing film 20 has a dichroic ratio within the range of about 3 to about 10 in a visible ray wavelength region, the dichroic dyes 22 are arranged according to arrangement of polymer chains, improving polarization properties of the polarizing film 20.

The polarizing film 20 may have light transmittance of greater than or equal to about 30%, and specifically, ranging from about 30% to about 95%. When the polarizing film 20 having light transmittance within the range is applied to one side of a display device, light emitting from the display device may not be prevented.

The polarizing film 20 may be a melt-blend of the polymer and the dichroic dye. The melt-blend may be obtained by melt-blending a composition for a polarizing film including the polymer and the dichroic dye at a temperature greater than or equal to a melting point (“Tₘ”) of the polymer 21.

The polarizing film may be applied to various display devices.

The display device may be a liquid crystal display (“LCD”).

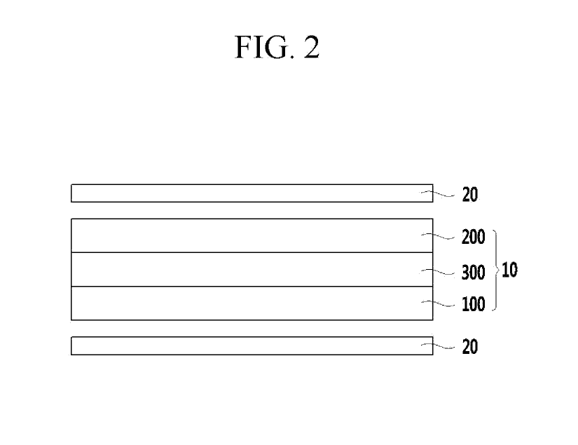

FIG. 2 is a cross-sectional view showing a liquid crystal display (LCD) according to an embodiment.

Referring to FIG. 2, the LCD an embodiment includes a liquid crystal display panel 10 and a polarizing film 20 disposed on both the lower part and the upper part of the liquid crystal display panel 10.

The liquid crystal panel 10 may be a twist nematic (“TN”) mode panel, a patterned vertical alignment (“PVA”) mode panel, an in-plane switching (“IPS”) mode panel, an optically compensated bend (“OCB”) mode panel, or the like.

The liquid crystal display panel 10 includes a first display panel 100, a second display panel 200, and a liquid crystal layer 300 interposed between the first display panel 100 and the second display panel 200.

The first display panel 100 may include, for example, a thin film transistor (not shown) formed on a substrate (not shown) and a first field generating electrode (not shown) connected thereto. The second display panel 200 may include, for example, a color filter (not shown) formed on the substrate and a second field generating electrode (not shown). However, it is not limited thereto, and the color filter may be included in the first display panel 100; and both the first field generating electrode and the second field generating electrode may be disposed in the first display panel 100.

The liquid crystal layer 300 may include a plurality of liquid crystal molecules. The liquid crystal molecules may have positive or negative dielectric anisotropy. When the liquid crystal molecules have positive dielectric anisotropy, the long axis thereof may be aligned substantially parallel to the surface of the first display panel 100 and the second display panel 200 when not applying an electric field, and may be aligned substantially perpendicular to the surface of the first display panel 100 and the second display panel 200 when applying an electric field. On the contrary, when the liquid crystal molecules have negative anisotropy, the long axis thereof may be aligned substantially perpendicular to the surface of the first display panel 100 and the second display panel 200 when not applying an electric field, and may be aligned substantially parallel to the surface of the first display panel 100 and the second display panel 200 when applying an electric field.

The polarizing film 20 is disposed on the outside of the liquid crystal display panel 10. Although it is shown to be disposed on the upper part and lower part of the liquid crystal display panel 10 in the drawing, it may be formed on either the upper part or the lower part of liquid crystal display panel 10.

The polarizing film 20 includes a polymer, a dichroic dye, and a liquid crystal oligomer that are the same as described above.

Even though only one example in which the polarizing film according to an embodiment is applied to a liquid crystal display (LCD) is described above, it may be equally applied to any display device including a polarizing plate or a polarizing film, for example, to an organic light emitting device (OLED) or the like.

Hereinafter, the present disclosure is illustrated in more detail with reference to examples. However, they are exemplary embodiments of the present disclosure, and the present disclosure is not limited thereto.

Synthesis of Liquid Crystal Oligomer

In an 1,000 milliliters (“ml”) flask, 32.83 g (0.2 mol) of 5-norbornene-2,3-dicarboxylic anhydride (nadic anhydride) is added to 400 ml of acetic acid (glacial) and the resulting mixture is heated at 110° C. until the solid content is dissolved. To this mixture, 41.1 g (0.3 mol) of 4-aminobenzoic acid is added. After addition, the reaction mixture was agitated for 2 hours and cooled to room temperature. The formed precipitate was washed with acetic acid and water and dried in a vacuum oven at 60° C. to provide 4-nadimidobenzoic acid in a yield of 95%.

10.798 g (0.065 mol) of isophthalic acid, 23.974 g (0.127 mol) of 6-hydroxy-2-naphthoic acid, 17.60 g (0.127 mol) of 4-hydroxy-benzoic acid, 14.187 g (0.130 mol) of 4-aminophenol, and 58.396 g (9.5 mol) of acetic anhydride were placed into a 500 ml flask equipped with a condenser and a mechanical stirrer, and the mixture was carefully heated at 140° C. under a nitrogen atmosphere for 3 hours to complete the acetylation reaction. Subsequently, 36.79 g (0.130 mol) of 4-nadimidobenzoic acid, prepared as described above, is added thereto, and the resulting mixture was heated to 215° C. at a rate of 1 to 2° C. per minute while removing the side products of acetic acid and non-reacted acetic anhydride by distillation. The resulting mixture was then allowed to react at 215° C. for 4 hours to provide a liquid crystal oligomer represented by the following Chemical Formula A (mp: 150° C.).

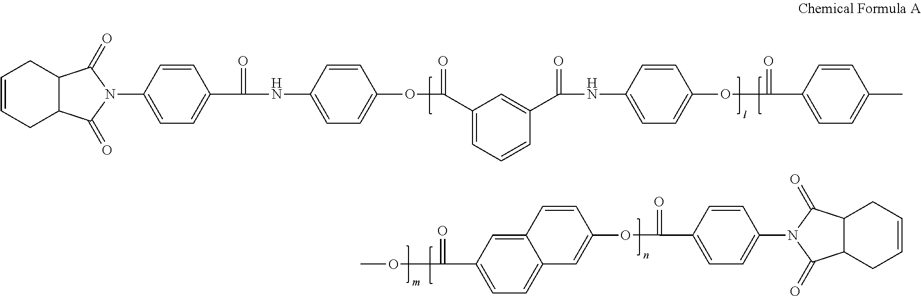

The liquid crystal oligomer has a number average molecular weight (“Mn”) of 3,300 Da.

### Manufacture of Polarizing Film

### Example 1-1

98.5 percent by weight (“wt %”) of polypropylene, 0.5 wt % of dichroic dye (Ciba Black, BASF, Germany) and 1 wt % of the liquid crystal oligomer were blended together to provide a composition for a polarizing film.

The composition for a polarizing film was melted at a temperature of about 230° C. The molten mixture was then put into a mold having a shape of a sheet and compressed with a roller to provide a film. The resulting film was uniaxially elongated at each rate of 300%, 400%, 500%, 600%, 700%, and 800% at 115° C. to provide a polarizing film.

### Example 1-2

96.5 wt % of polypropylene, 0.5 wt % of dichroic dye (Ciba Black, BASF, Germany), and 3 wt % of the liquid crystal oligomer were blended together to provide a composition for a polarizing film.

The composition for a polarizing film is melted at a temperature of about 230° C. The molten mixture was then put into a mold having a shape of a sheet and compressed with a roller to provide a film. The resulting film was uniaxially elongated at each rate of 300%, 400%, 500%, 600%, 700%, and 800% at 115° C. to provide a polarizing film.

### Example 2

98.6 wt % of glycol modified polyethylene terephthalate (PETG”), 0.2 wt % of dichroic dye 1 (Nazo, manufactured by Nematel), 0.1 wt % of dichroic dye 2 (G241, manufactured by Hayashibara), 0.1 wt % of dichroic dye 3 (AC1, manufactured by Nematel), and 1 wt % of the liquid crystal oligomer were blended together to provide a composition for a polarizing film.

The composition for a polarizing film was melted at a temperature of about 230° C. The molten mixture was then put into a mold having a shape of a sheet and was compressed with a roller to provide a film. The film was uniaxially elongated at a rate of 500% at 80° C. to provide a polarizing film.

### Comparative Example 1

99.5 wt % of polypropylene and 0.5 wt % of dichroic dye (Ciba Black, BASF, Germany) are blended to provide a composition for a polarizing film.

The composition for a polarizing film was melted at a temperature of about 230° C. The molten mixture was then put into a mold having a shape of a sheet and compressed with a roller to provide a film. The resulting film was uniaxially elongated at each rate of 300%, 400%, 500%, 600%, 700%, and 800% at 115° C. to provide a polarizing film.

### Comparative Example 2

99.6 wt % of glycol modified polyethylene terephthalate (PETG”), 0.2 wt % of dichroic dye 1 (Nazo, manufactured by Nematel), 0.1 wt % of dichroic dye 2 (G241, manufactured by Hayashibara), and 0.1 wt % of dichroic dye 3 (AC1, manufactured by Nematel) were blended together to provide a composition for a polarizing film.

The composition for a polarizing film was melted at a temperature of about 230° C. The molten mixture was put into a mold having a shape of a sheet and compressed with a roller to provide a film. The resulting film was uniaxially elongated at a rate of 500% at 80° C. to provide a polarizing film.

### Comparative Example 3

96.8 wt % of a mixed polymer (mixing ratio: 50:50 by weight) of polypropylene and a polypropylene-polyethylene copolymer, 0.2 wt % of dichroic dye (G241, manufactured by Hayashibara), and 3 wt % of nematic liquid crystal (TL203, manufactured by Merck) were blended together to provide a composition for a polarizing film.

(Note: TL203 refers to a nematic liquid crystal having pentyl cyanobiphenyl (5CB)/fluoro-chloro-substituted mesogens and having no kink structure in the molecule).

The composition for a polarizing film was melted at a temperature of about 230° C. The molten mixture was placed into a mold having a shape of sheet and compressed with a roller to provide a film. The film was uniaxially elongated at a rate of 1,000% at 115° C. to provide a polarizing film.

### Comparative Example 4

99.8 wt % of a mixed polymer (mixing ratio: 50:50 by weight) of polypropylene and a polypropylene-polyethylene copolymer and 0.2 wt % of dichroic dye (G241, manufactured by Hayashibara) were blended together to provide a composition for a polarizing film.

The composition for a polarizing film was then melted at a temperature of about 230° C. The molten mixture was put into a mold having a shape of a sheet and compressed with a roller to provide a film. The film was uniaxially elongated at a rate of 1,000% at 1,150° C. to provide a polarizing film.

Evaluation 1

The polarizing films according to Examples 1-1 and 1-2 and Comparative Example 1 were evaluated for polarizing efficiency (PE”).

The polarizing efficiency was measured based on transmittance of 40% at a wavelength of 550 nanometers (“nm”).

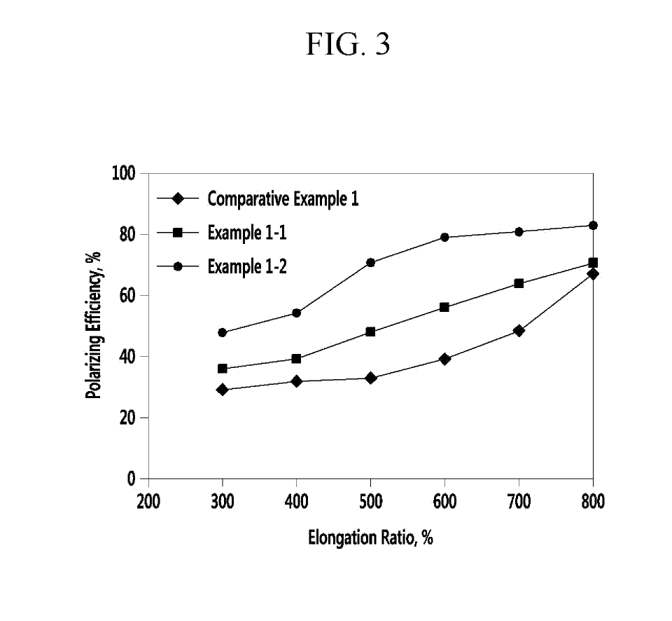

The results are shown in Table 4 and FIG. 3.

FIG. 3 is a graph showing polarizing efficiency of polarizing films according to Examples 1-1 and 1-2 and Comparative Example 1.

TABLE 4

| | Polarizing efficiency (%) | | |
|---|---|---|---|
| Elongation | | | Comparative |
| ratio (%) | Example 1-1 | Example 1-2 | Example 1 |
| 300 | 36.0 | 47.7 | 29.4 |
| 400 | 39.2 | 54.0 | 32.0 |
| 500 | 47.8 | 70.0 | 33.2 |
| 600 | 55.9 | 78.4 | 39.0 |
| 700 | 63.5 | 80.0 | 48.2 |
| 800 | 70.0 | 82.0 | 66.5 |

Referring to Table 4 and FIG. 3, it is understood that the polarizing films according to Example 1-1 and 1-2 have improved polarizing efficiency compared to the polarizing film according to Comparative Example 1.

Evaluation 2

The polarizing films according to Example 2 and Comparative Example 2 were evaluated for light transmittance, dichroic ratio, and polarizing efficiency (PE”).

The light transmittance (“Ts”) means light transmittance of a single film in a visible ray region (350 to 780 nm), wherein each light transmittance of a polarizing film with respect to the light entering in parallel to a transmissive axis of a polarizing film and light transmittance of a polarization film with respect to the light entering perpendicularly to a transmissive axis of a polarization film was measured using a UV-VIS Spectrophotometer (JASCO, V-7100, Konica-Minolta).

The dichroic ratio was obtained according to the Equation 1 using the measured light absorbance.

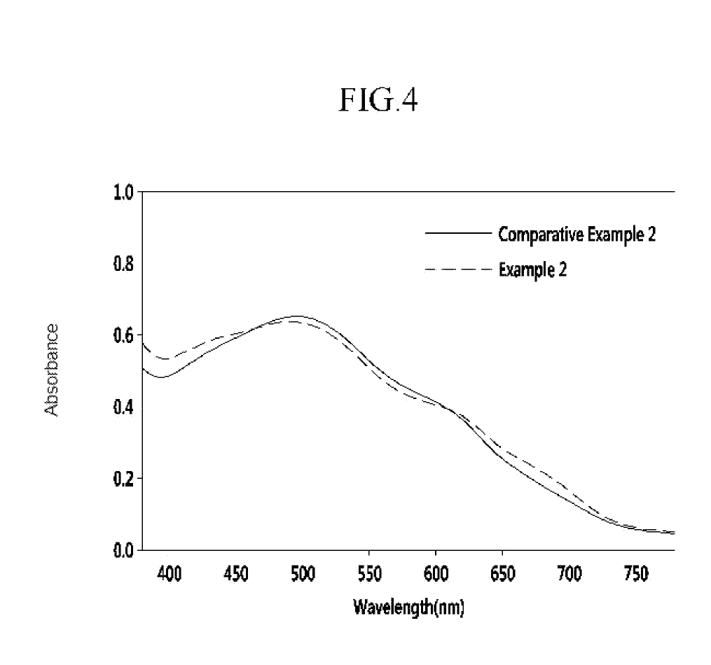

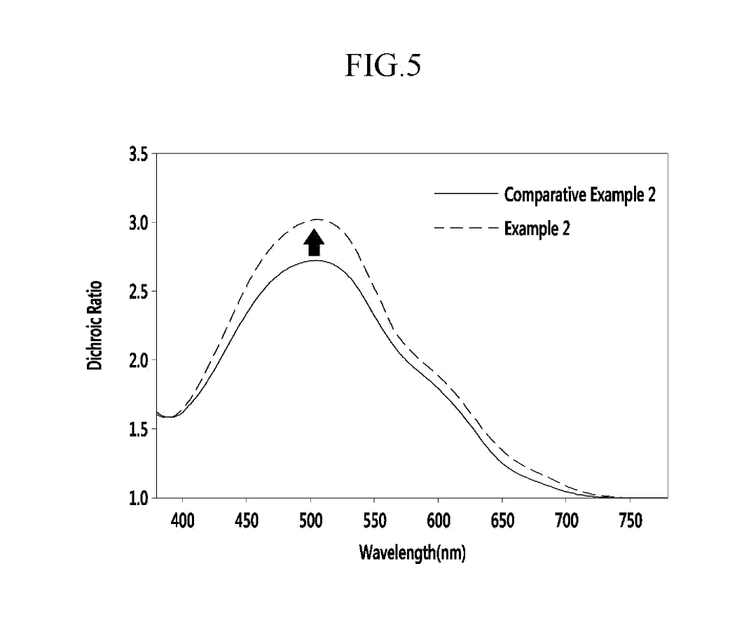

The results are shown in Table 5 and FIGS. 4 and 5.

FIG. 4 is a graph showing the absorbance at a wavelength range of 380 to 780 nm in polarizing films according to Example 2 and Comparative Example 2, and FIG. 5 is a graph showing the dichroic ratio of polarizing films according to Example 2 and Comparative Example 2.

TABLE 5

| | | | Comparative |
|---|---|---|---|
| | | Example 2 | Example 2 |
| Light transmittance (Ts, %) | | 32.6 | 31.9 |
| Polarizing efficiency (PE, %) | | 86.8 | 85.1 |
| Dichroic | 400 nm | 1.6 | 1.6 |
| ratio | 450 nm | 2.5 | 2.3 |
| | 500 nm | 3.1 | 2.7 |
| | 550 nm | 2.5 | 2.3 |
| | 600 nm | 1.9 | 1.8 |
| | 650 nm | 1.4 | 1.2 |
| | 700 nm | 1.1 | 1.1 |
| | average | 2.2 | 1.9 |

Referring to Table 5 and FIGS. 4 and 5, it can be understood that the polarizing film according to Example 2 has similar light transmittance to the polarizing film according to Comparative Example 2 and improves the polarizing efficiency and the dichroic ratio. Thereby, one may conclude that the liquid crystal oligomer may improve the polarization property while not affecting the light transmittance of the polarizing film.

Evaluation 3

The polarizing films according to Comparative Examples 3 and 4 were compared for polarization properties. This evaluation was to confirm whether the polarization properties would be improved even in the case of including the commercially available nematic liquid crystal instead of the liquid crystal oligomer according to this embodiment.

The results are shown in Table 6.

TABLE 6

| | Comparative | Comparative |
|---|---|---|
| | Example 3 | Example 4 |
| Ts (%) | 32.38 | 41.23 |
| T_{∥} (%) | 18.17 | 29.18 |
| T_{⊥} (%) | 2.80 | 4.83 |
| Polarizing efficiency | 85.61 | 84.62 |
| (PE, %) | | |
| Dichroic ratio (DR) | 2.09 | 2.46 |
| Film thickness(D, μm), | 45 | 32 |

Referring to Table 6, it can be understood that the polarizing film including the commercially available nematic liquid crystal had insufficiently improved polarization properties and poor light transmittance compared to the film including no commercially available nematic liquid crystal. Accordingly, it can be understood that the polarization film including the commercially available nematic liquid crystal does not accomplish the effects of improving the polarization properties and maintaining the light transmittance, which are improved when using the liquid crystal oligomer according to the embodiments in Evaluations 1 and 2.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A composition for a polarizing film, comprising:
a polymer;
a dichroic dye; and
a liquid crystal oligomer,
wherein the liquid crystal oligomer comprises a mesogen unit and a kink-forming arylene unit.

2. The composition of claim 1, wherein the liquid crystal oligomer is represented by Chemical Formula 1:
T₁-L₁-(Ar₁)ₙ-L₂-(Ar₂)ₘ-L₃-T₂ Chemical Formula 1
wherein, in Chemical Formula 1,
Ar₁ is the kink-forming arylene unit,
Ar₂ is the mesogen unit,
L₁, L₂, and L₃ are the same or different, and are each a linking group,
T₁ and T₂ are each independently a C1 to C20 aromatic or aliphatic group without a hydrophilic functional group, and
n and m are mole ratios wherein 0.05≦n≦0.6 and 0.4≦m≦0.95.

3. The composition of claim 2, wherein Ar₁ of the Chemical Formula 1 is represented by Chemical Formula 2:
—[X₁-A₁-Y₁]— Chemical Formula 2
wherein, in Chemical Formula 2,
A₁ is an arylene group having a kink structure,
X₁ and Y₁ are each independently —C(═O)O—, —OC(═O)—, —C(═O)—, —O—, —C(═N)(R^{a})—, —C(═O)N(R^{b})—, —N(R^{c})—, —N(R^{d})C(═O)—, —C(═O)N(R^{e})—, or a combination thereof, wherein R^{a} to R^{e} are each independently hydrogen, a substituted or unsubstituted C1 to C30 alkyl group, a substituted or unsubstituted C6 to C30 aryl group, or a combination thereof.

4. The composition of claim 3, wherein A₁ of the Chemical Formula 2 comprises at least one selected from Groups 1-1 to 1-6:
Group 1-1 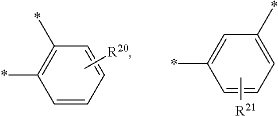
Group 1-2 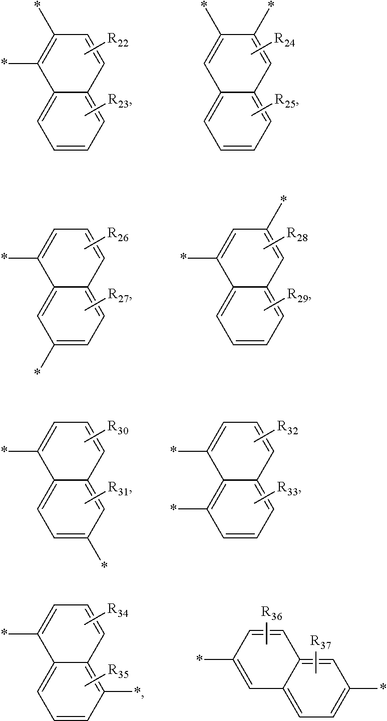
Group 1-3 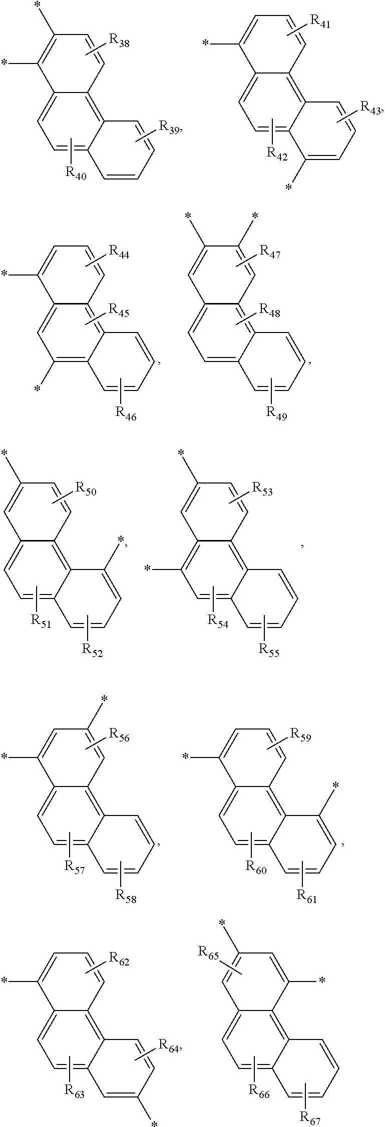
Group 1-4 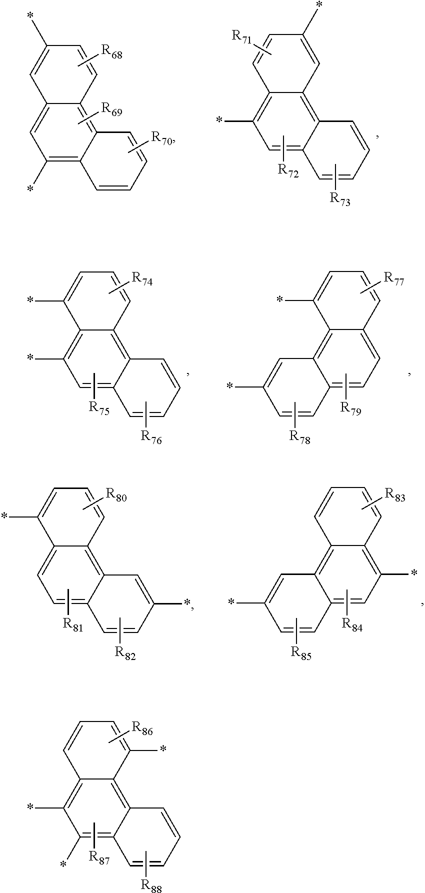
Group 1-5 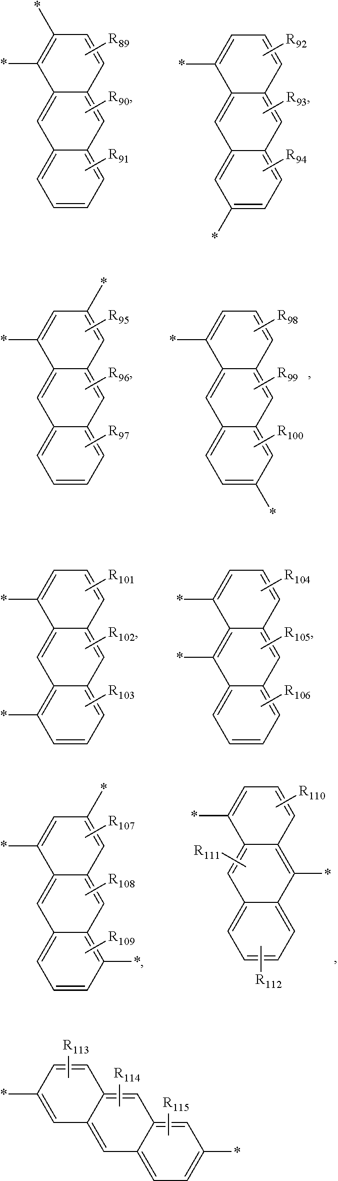
Group 1-6 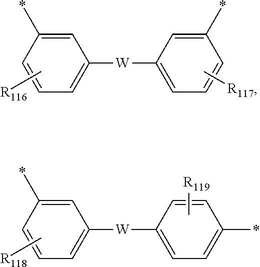
wherein, in Groups 1-1 to 1-6,
R₂₀ to R₁₁₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C3 to C30 cycloalkenyl group, a substituted or unsubstituted C7 to C20 arylalkyl group, a substituted or unsubstituted C1 to C20 heteroalkyl group, a substituted or unsubstituted C2 to C30 heterocycloalkyl group, a substituted or unsubstituted C2 to C30 heteroaryl group, a substituted or unsubstituted C2 to C30 alkenyl group, a substituted or unsubstituted C2 to C30 alkynyl group, a substituted or unsubstituted C1 to C20 acyl group, a substituted or unsubstituted amino group, a halogen atom, a halogen-containing group, or a combination thereof; and
W is a single bond, —O—, —C(═O)—, —S—, —SO₂—, —N₂—, a substituted or unsubstituted C1 to C20 alkylene group, a substituted or unsubstituted C1 to C20 oxyalkylene group, a substituted or unsubstituted C6 to C30 arylene group, a substituted or unsubstituted C6 to C30 oxyarylene group, a substituted or unsubstituted C6 to C30 heteroarylene group, a substituted or unsubstituted C6 to C30 oxyheteroarylene group, or a combination thereof.

5. The composition of claim 2, wherein Ar₂ of the Chemical Formula 1 is represented by Chemical Formula 3:
—[X₂-A₂-Y₂]— Chemical Formula 3
wherein, in Chemical Formula 3,
A₂ is a group including a substituted or unsubstituted C3 to C30 cycloalkylene group, a substituted or unsubstituted C6 to C30 arylene group, a substituted or unsubstituted C3 to C30 heterocycloalkylene group, a substituted or unsubstituted C3 to C30 heteroarylene group, or a combination thereof, and
X₂ and Y₂ are each independently —O—, —C(═O)—, a substituted or unsubstituted C1 to C30 alkylene group, a substituted or unsubstituted C1 to C30 oxyalkylene group, or a combination thereof.

6. The composition of claim 5, wherein A₂ of the Chemical Formula 3 may include at least one selected from Group 2:
Group 2 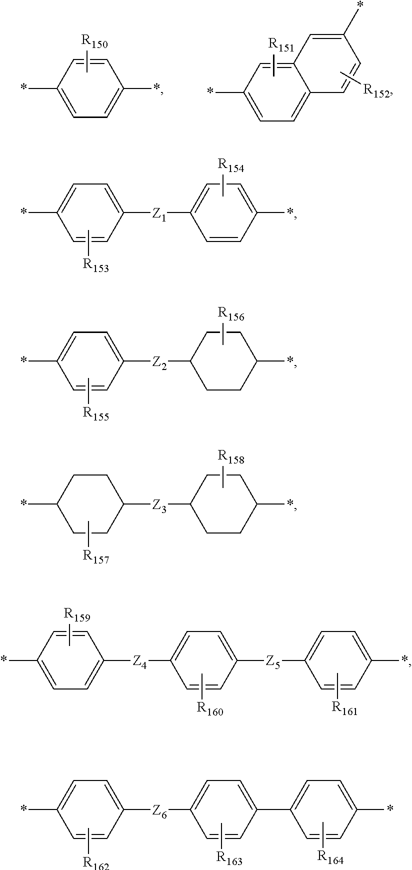
wherein, in Group 2,
Z₁ to Z₆ are each independently a single bond, —O—, —C(═O)—, —S—, —SO₂—, —N₂—, a substituted or unsubstituted C1 to C20 alkylene group, a substituted or unsubstituted C1 to C20 oxyalkylene group, a substituted or unsubstituted C6 to C30 arylene group, a substituted or unsubstituted C6 to C30 oxyarylene group, a substituted or unsubstituted C6 to C30 heteroarylene group, a substituted or unsubstituted C6 to C30 oxyheteroarylene group, or a combination thereof; and
R₁₅₀ to R₁₆₄ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C3 to C30 cycloalkenyl group, a substituted or unsubstituted C7 to C20 arylalkyl group, a substituted or unsubstituted C1 to C20 heteroalkyl group, a substituted or unsubstituted C2 to C30 heterocycloalkyl group, a substituted or unsubstituted C2 to C30 heteroaryl group, a substituted or unsubstituted C2 to C30 alkenyl group, a substituted or unsubstituted C2 to C30 alkynyl group, a substituted or unsubstituted C1 to C20 acyl group, a substituted or unsubstituted amino group, a halogen atom, a halogen-containing group, or a combination thereof.

7. The composition of claim 5, wherein A₂ of the Chemical Formula 1 is represented by Chemical Formula 3a:
—[X₂₁-A₂₁-Y₂₁]ₖ₁—[X₂₂-A₂₂-Y₂₂]ₖ₂—[X₂₃-A₂₃-Y₂₃]ₖ₃—[X₂₄-A₂₄-Y₂₄]ₖ₄— Chemical Formula 3a
wherein, in Chemical Formula 3a,
A₂₁, A₂₂, A₂₃, and A₂₄ are each independently a substituted or unsubstituted C3 to C30 cycloalkylene group, a substituted or unsubstituted C6 to C30 arylene group, a substituted or unsubstituted C3 to C30 heterocycloalkylene group, a substituted or unsubstituted C3 to C30 heteroarylene group, or a combination thereof,
X₂₁, X₂₂, X₂₃, X₂₄, Y₂₁, Y₂₂, Y₂₃, and Y₂₄ are each independently —O—, —C(═O)—, a substituted or unsubstituted C1 to C20 alkylene group, a substituted or unsubstituted C1 to C20 oxyalkylene group, or a combination thereof,
k₁ to k₄ are each independently 0 to 50, and
at least one of k₁ to k₄ is not 0.

8. The composition of claim 2, wherein T₁ and T₂ of the Chemical Formula 1 are each independently at least one of Chemical Formulae 4-1 to 4-12: 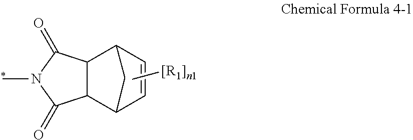
wherein, in Chemical Formula 4-1,
n₁ is an integer ranging from 0 to 6,
R₁ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁ is 2 or more, the substituents are the same or different, 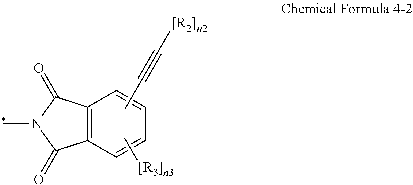
wherein, in Chemical Formula 4-2,
n₂ is 1, n₃ is an integer ranging from 0 to 3,
R₂ is a substituent selected from hydrogen, a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and
R₃ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₃ is 2 or more, the substituents are the same or different. 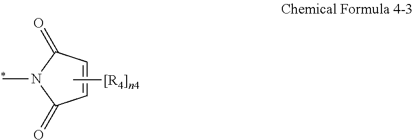
wherein, in Chemical Formula 4-3,
n₄ is an integer ranging from 0 to 2,
R₄ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₄ is 2, the substituents are the same or different, 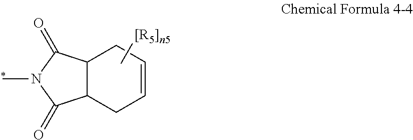
wherein, in Chemical Formula 4-4,
n₅ is an integer ranging from 0 to 8,
R₅ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₅ is 2 or more, the substituents are the same or different, 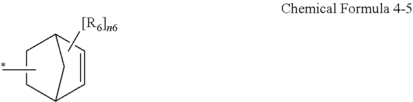
wherein, in Chemical Formula 4-5,
n₆ is an integer ranging from 0 to 7,
R₆ is a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₆ is 2 or more, the substituents are the same or different, 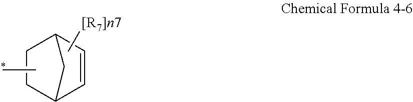
wherein, in Chemical Formula 4-6,
n₇ is an integer ranging from 0 to 9,
R₇ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group and when n₇ is 2 or more, the substituents are the same or different, 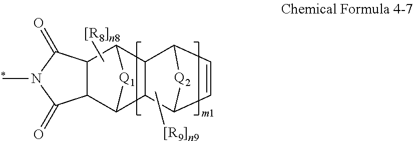
wherein, in Chemical Formula 4-7,
m₁ is an integer ranging from 1 to 3,
n₈ and n₉ are each independently integers ranging from 0 to 6,
R₈ and R₉ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₈ and n₉ are 2 or more, the substituents are the same or different, and
Q₁ and Q₂ are each independently a methylene group, —O—, or —S—, 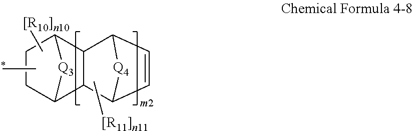
wherein, in Chemical Formula 4-8,
m₂ is an integer ranging from 1 to 3,
n₁₀ is an integer ranging from 0 to 7, n₁₁ is an integer ranging from 0 to 6,
R₁₀ and R₁₁ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁₀ and n₁₁ are 2 or more, the substituents are the same or different, and
Q₃ and Q₄ are each independently a methylene group, —O—, or —S—, 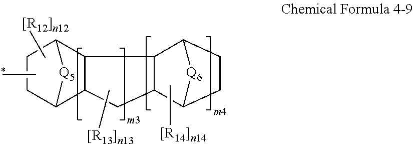
wherein, in Chemical Formula 4-9,
m₃ and m₄ are each independently integers ranging from 1 to 3,
n₁₂ is an integer ranging from 0 to 7, n₁₃ is an integer ranging from 0 to 6, n₁₄ is an integer ranging from 0 to 8,
R₁₂ to R₁₄ are each independently substituents selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group, and when n₁₂ and n₁₃ are 2 or more, the substituents are the same or different, and
Q₅ and Q₆ are each independently a methylene group, —O—, or —S—, 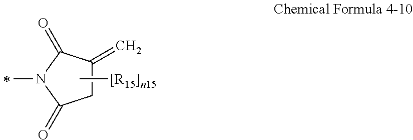
wherein, in Chemical Formula 4-10,
n₁₅ is an integer ranging from 0 to 2,
R₁₅ is a substituent selected from a halogen atom, a substituted or unsubstituted C1 to C20 alkyl group, a substituted or unsubstituted C1 to C20 alkoxy group, a substituted or unsubstituted C6 to C30 aryl group, or a substituted or unsubstituted C6 to C30 aryloxy group,
*—C≡CH, and Chemical Formula 4-11
*—C≡N Chemical Formula 4-12.

9. The composition of claim 1, wherein the liquid crystal oligomer has a melting point of less than or equal to about 250° C.

10. The composition of claim 1, wherein the liquid crystal oligomer has a solubility parameter of about 15 to about 30.

11. The composition of claim 1, wherein the polymer comprises at least one of polyolefin, polyethylene terephthalate, glycol modified polyethylene terephthalate, polyester, nylon, copolymers thereof.

12. The composition of claim 1, wherein a solubility parameter difference between the polymer and the dichroic dye is less than 7.4,

13. The composition of claim 1, wherein the polymer is a polyolefin, and the dichroic dye is represented by the Chemical Formula 1 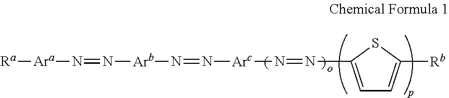
wherein, in Chemical Formula 1,
Ar^{a} to Ar^{c} are each independently a substituted or unsubstituted C6 to C15 arylene group,
R^{a} and R^{b} are each independently a substituted or unsubstituted C1 to C30 aliphatic group, a substituted or unsubstituted C3 to C8 cycloaliphatic group, a substituted or unsubstituted C6 to C30 aromatic group, a substituted or unsubstituted C1 to C30 hetero aliphatic group, a substituted or unsubstituted C1 to C30 hetero aromatic group, or a combination thereof, and
o and p are independently 0 or 1.

14. The composition of claim 1, wherein R^{a} is a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and
R^{b} is a substituted or unsubstituted C1 to C30 alkyl group, a substituted or unsubstituted C6 to C20 aryl group, a substituted or unsubstituted C1 to C20 alkoxy group, a substituted or unsubstituted C1 to C20 thioalkyl group, —NR^{c}R^{d}, or a combination thereof, wherein R^{c} and R^{d} are each independently hydrogen, a substituted or unsubstituted C1 to C10 alkyl group or are linked to each other to form a ring.

15. The composition of claim 1, wherein when each of o and p is 1,
R^{a} is a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and
R^{b} is a substituted or unsubstituted C1 to C30 alkyl group, a substituted or unsubstituted C6 to C20 aryl group, —NR^{c}R^{d}, or a combination thereof, wherein R^{c} and R^{d} are each independently hydrogen, a substituted or unsubstituted C1 to C10 alkyl group, or are linked to each other to form a ring.

16. The composition of claim 1, wherein when each of o and p is 0,
R^{a} is a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and
R^{b} is a substituted or unsubstituted C1 to C30 alkyl group, —NR^{c}R^{d}, or a combination thereof, wherein R^{c} and R^{d} are each independently hydrogen, a substituted or unsubstituted C1 to C10 alkyl group, or are linked to each other to form a ring.

17. The composition of claim 1, wherein when o is 1 and p is 0,
R^{a} is a substituted or unsubstituted C1 to C30 alkyl group, a substituted or unsubstituted C1 to C20 alkoxy group, a substituted or unsubstituted C1 to C20 thioalkyl group, a substituted or unsubstituted C3 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and
R^{b} is a substituted or unsubstituted C1 to C30 alkyl group, a substituted or unsubstituted C6 to C30 aryl group, —NR^{c}R^{d}, or a combination thereof, wherein R^{c} and R^{d} are each independently hydrogen, a substituted or unsubstituted C1 to C10 alkyl group, or are linked to each other to form a ring.

18. The composition of claim 1, wherein an amount of the liquid crystal oligomer and the dichroic dye are about 0.01 to 10 parts by weight and 0.05 to about 5 parts by weight based on a total of 100 parts by weight of the polymer, respectively.

19. A uniaxially elongated polarizing film comprising the composition for a polarizing film according to claim 1.

20. A display device comprising the polarizing film according to claim 19.
